(19) United States
(12) Patent Application Publication
(10) Pub. No.: US 2008/0208962 A1
(43) Pub. Date: Aug. 28, 2008

(54) Real time automatic update system and method for disaster damage investigation using wireless communication and web-gis

(75) Inventors: Kyehyun Kim, Incheon (KR); Jongkook Lee, Seongnam-si (KR)

Correspondence Address: BACON & THOMAS, PLLC, 625 SLATERS LANE, FOURTH FLOOR, ALEXANDRIA, VA, 22314, US

(73) Assignees: INHA-INDUSTRY PARTNERSHIP INSTITUTE, Incheon (KR); DATA PCS CO., LTD, Seongnam-si (KR)

(21) Appl. No.: 11/802,620

(22) Filed: May 24, 2007

(30) Foreign Application Priority Data
Feb. 27, 2007 (KR) 10-2007-0019458

(51) Int. Cl. G06F 15/16

(52) U.S. Cl. 709/203

(57) ABSTRACT

Disclosed are a real time automatic update system and method for disaster damage investigation using wireless communication and a web-GIS (Geographic Information System), which are able to prevent disaster recurrence by effectively acquiring various data associated with a disaster area in disaster investigation, quickly establish a disaster register and enable easy searching by loading corresponding data on the web. The system includes a field equipment kit which is comprised of various kinds of equipments for capturing the location of a damaged area, damage cause information, damage images and moving images, and voice information and transmitting them to a server; a damage investigation information receiving server which receives data that is created in the field equipment kit and transmitted therefrom through wireless communication, analyzes/stores disaster data, and classifies/processes the disaster data; a web server which receives data classified suitably for a homepage, a disaster register, a web-GIS, etc. and establishes a disaster register DB and a web DB; a web-GIS server which updates and stores geographical information and geographical property information linked with the web server; and a client terminal which connects to the web server and the web-GIS server to generate a retrieval signal of disaster information and displays the information on the screen.

### FIELD OF THE INVENTION

The present invention relates to a real time automatic update system and method for disaster damage investigation using wireless communication and a web-GIS (Geographic Information System), and more particularly, to a real time automatic update system and method for disaster damage investigation using wireless communication and a web-GIS, which are able to prevent disaster recurrence by effectively acquiring various data about a disaster area in disaster investigation, quickly establish a disaster register and enable easy searching by loading corresponding data on the web.

### BACKGROUND OF THE INVENTION

With a recent development in information communication technology, the development of information provision technology offering information on various fields to multiple subscribers in real time via at least one host server over a remote data communication network is actively in progress.

Based on this, peripheral technology, such as cache memory expansion technology for providing precise information to subscribers more rapidly, and information screening technology and compression technology capable of approaching to the taste and preference of subscribers more conveniently, are being developed in recent years. Moreover, the development of various electronic contents and their solutions through the above technologies are also being accelerated.

The existing damage investigation and restoration system is lack in rapidity and objectivity in a damage investigation process because it is mostly dependent on manual work, which consumes much labor and time.

The problems of a system established for the existing damage investigation and restoration system can be described concretely as follows:

i) since the system established for the existing damage investigation and restoration system is mostly dependent on manual work, there are a lot of difficulties in assessing the extent of disaster damage and estimating the scale of damage and the amount of damage due to the absence of scientific and standardized site investigation equipment and the extensiveness of a damage area. Therefore, the investigation has to depend on arbitrary assessment of an investigator who is in charge of on-site damage investigation, and such a subjective assessment may cause an enormous error in the estimation of an actual scale of damage and amount of damage;

ii) there is a difficulty in deducing result items and preparing the ground for estimation because there is no investigation process and investigation equipment standardized for each local authority that performs on-site investigation;

iii) much labor and time are consumed because most of the process is carried out by manual work in the process of result deduction and damage estimation after doing the investigation, and there is also a risk of error occurrence;

iv) there exists a difficulty caused by the lack of ground data and ambiguity of standards of estimation when estimating the amount of damage from the result of investigation;

v) it is difficult to acquire the ground for estimation of the scale and amount of damage, and thus, inhabitants' confidence in policy in damaged areas is decreased;

vi) people's awareness of disaster prevention and confidence in disaster prevention policy have not been attained because the disclosure of sophisticated and comprehensive disaster prevention information and investigation results, such as the disclosure of images through a GIS and the internet, is not carried out;

vii) as for the preservation of an investigation result, the process of drawing up a register and storing data for preservation is done separately after drawing up and collecting an investigation result on site, which requires double and triple work to consume much labor and causes a delay of disaster restoration due to lack of labor; and

viii) it is difficult to search and disclose a disaster register, which leads to a lot of time and economic consumption in the preparation of the ground for establishment of follow-up measures, so that the same disaster may recur frequently in the same place.

### SUMMARY OF THE INVENTION

Therefore, the present invention has been made in view of the above problems of the prior arts, and it is a primary object of the present invention to provide a real time automatic update system and method for disaster damage investigation using wireless communication and a web-GIS, which provide investigation equipment capable of ensuring the objectivity of estimation of each damage scale, ensuring a scientific basis therefor and quickly and accurately performing an investigation process by the use of equipment such as a digital camera, a GPS, a voice recorder, wireless ultrahigh-speed communication equipment and so on when a disaster damage investigation for damage of lives and other various kinds of damages of natural objects, artificial objects, etc. is conducted, which performs various data operations for arranging, entering, storing and processing an investigated result, sends the arranged data to each server to automatically process them in real time in the form of information suited to a given type and post them in the homepage, main page and bulletin and processes them in the form of a standardized disaster register to generate a web page, and which registers a disaster point on the web-GIS through disaster point coordinates or the like and displays the properties thereof and links the homepage, the disaster register, the web-GIS and so on in order to quickly search and check various information, whereby it is possible to support in rapidly establishing damage restoration measures and disaster prevention measures and supports, and confidence in public policy can be improved by attaining the transparency of disaster prevention and damage restoration measures by posting various information of a disaster investigation on the general internet.

In accordance with one aspect of the present invention, there is provided a real time automatic update system for disaster damage investigation using wireless communication and a web-GIS, the system comprising: a field equipment kit which is comprised of various kinds of equipments for capturing the location of a damaged area, damage cause information, damage images and moving images, and voice information and transmitting them to a server; a damage investigation information receiving server which receives data that is created in the field equipment kit and transmitted therefrom through wireless communication, analyzes/stores disaster data, and classifies/processes the disaster data; a web server which receives data classified suitably for a homepage, a disaster register, a web-GIS, etc. and establishes a disaster register DB and a web DB; a web-GIS server which updates and stores geographical information and geographical property information linked with the web server; and a client terminal which connects to the web server and the web-GIS server to generate a retrieval signal of disaster information and displays the information on the screen.

In accordance with another aspect of the present invention, there is provided a real time automatic update method for disaster damage investigation using wireless communication and a web-GIS, the method comprising the steps of: loading information of a disaster area through a field equipment kit and transmitting and registering the same to and in the a disaster investigation information receiving server; at the disaster investigation information receiving server, classifying the disaster area information into data for data for a web server and data for a web-GIS server and storing the same in the disaster DB, processing the corresponding disaster area information into a protocol operable for each server, and transmitting the same to each server; at the web server, analyzing the disaster area information transmitted from the disaster investigation information receiving server, creating the same as data for homepage display and disaster register data for webpages and storing the same in a homepage DB and a disaster register DB, and linking the corresponding homepage and the disaster register DB; at the web-GIS server, analyzing the disaster area information transmitted from the disaster investigation information receiving server, registering layers for new geographical information or additionally registering geographical graphics of the disaster area, and linking the corresponding information with the web GIS disaster register DB and the web server so as to be outputted in linkage with each other; and connecting to the web server or the web-GIS server through a client terminal and searching and outputting information of a specific disaster area or disaster type.

The other objectives and particular advantages of the present invention will be understood by the following description.

### BRIEF DESCRIPTION OF THE DRAWINGS

The above and other objects and features of the instant invention will become apparent from the following description of preferred embodiments taken in conjunction with the accompanying drawings, in which:

FIG. 1 is a block diagram schematically showing the overall structure of a real time automatic update system for disaster damage investigation using wireless communication and a web-GIS according to one embodiment of the present invention;

FIG. 2 is a detailed block diagram of a field equipment kit of FIG. 1;

FIGS. 3A, 3B, 3C, and 3D are detailed block diagrams of a portable damage investigation equipment, a damage investigation information receiving server, a web server and the web-GIS server of FIGS. 1 and 2, respectively;

FIG. 4 is a detailed block diagram of a web display information block of FIG. 1;

FIGS. 5A, 5B, 5C, and 5D are detailed block diagrams of system driving units of FIGS. 3A, 3B, 3C, and 3D, respectively;

FIG. 6 illustrates the configuration of a disaster investigation DB of FIG. 3A;

FIGS. 7A and 7B illustrate the configuration of a homepage DB and a disaster register DB of FIG. 3B, respectively;

FIGS. 8A, 8B, and 8C illustrate the configuration of a geographical graphic DB, a property DB and a system DB of FIG. 3C, respectively;

FIG. 9 describes the configuration of disaster and layer classification codes of the real time automatic update system for disaster damage investigation according to the present invention;

FIGS. 10A, 10B, 10C, 10D, 10E, 10F, and 10G are data flowcharts of the portable damage investigation equipment of FIG. 2, and the damage investigation information receiving server, the web server and the web-GIS server of FIG. 1;

FIG. 11 is a menu map of an on-site disaster input program of the portable disaster investigation equipment of FIG. 2;

FIG. 12 is a menu map of a homepage of FIG. 4;

FIG. 13 is a menu map of a web-GIS of FIG. 4;

FIGS. 14A, 14B, 14C, and 14D are menu screens of basic and location information, damage and image information, video and voice information, information summary and transmission and so on of the on-site disaster input program of the portable disaster investigation equipment of FIG. 2;

FIGS. 15A and 155B are basic and search screens of the homepage of FIG. 4;

FIG. 16 is an illustrative screen of a disaster register web page of FIG. 4;

FIG. 17 is an initial screen of the WeB-GIS of FIG. 4;

FIGS. 18A, 18B, 18C, and 18D are illustrative screens of a menu area, a layer tree area, an information display area and a map display area of the web-GIS of FIG. 4;

FIGS. 19A, 19B, and 19C are illustrative screens of a map display area when all layers of the web-GIS of FIG. 4 are displayed and large-scale, medium-scale and small-scale areas are selected;

FIG. 20 is an illustrative screen of a map display area when disaster information layers except for the basic information layer of the web-GIS of FIG. 4 are displayed; and

FIGS. 21A and 21B are illustrative screens before and after applying a virtual disaster scenario of Seongnam City in Korea in the web-GIS of FIG. 4.

### DETAILED DESCRIPTION OF THE INVENTION

Hereinafter, a preferred embodiment of the present invention will be described in more detail with reference to the accompanying drawings. The embodiment as provided below is only for illustrating the present invention and not for giving any limitation to the technical aspect or the scope of the present invention.

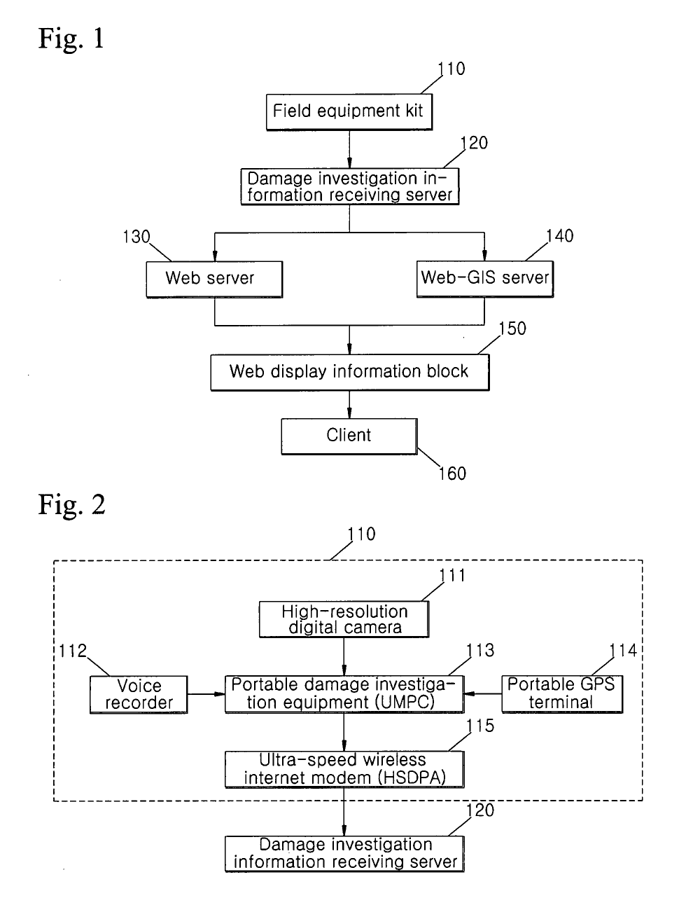

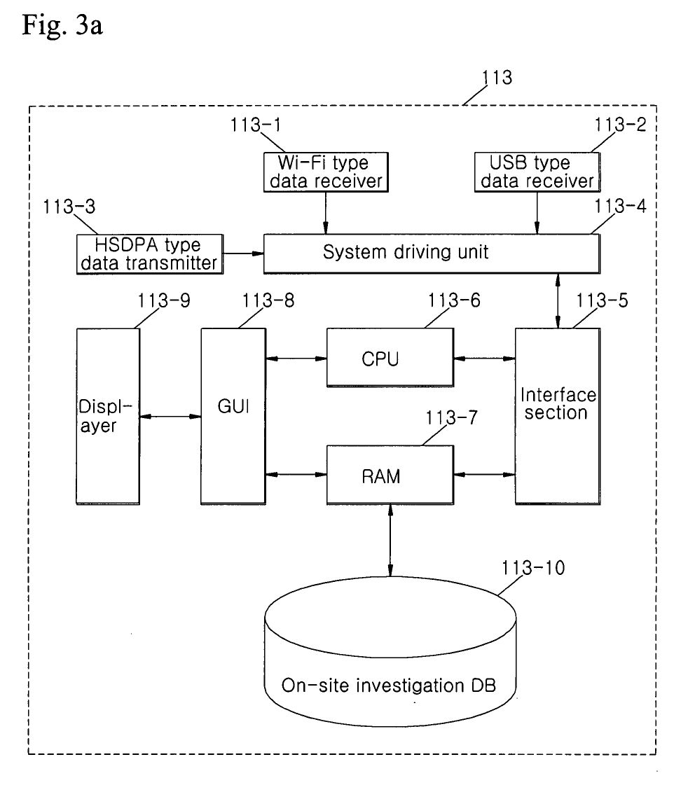

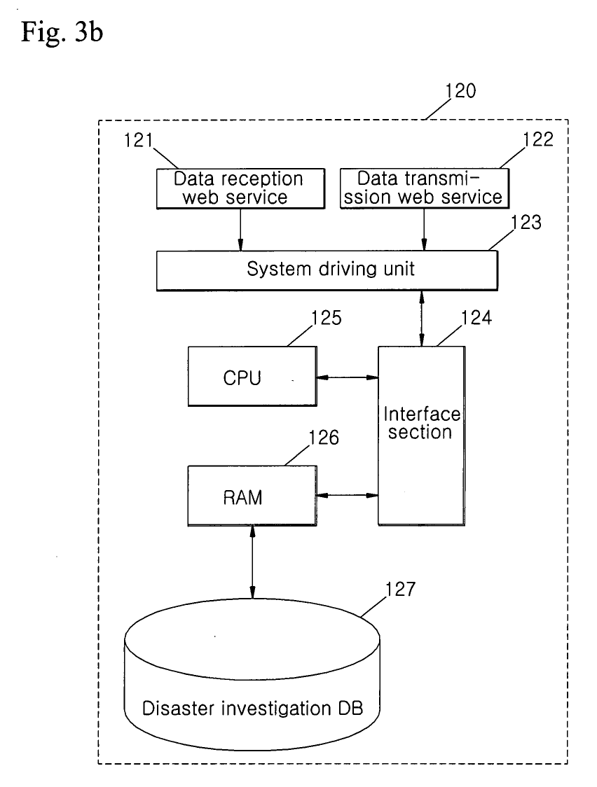

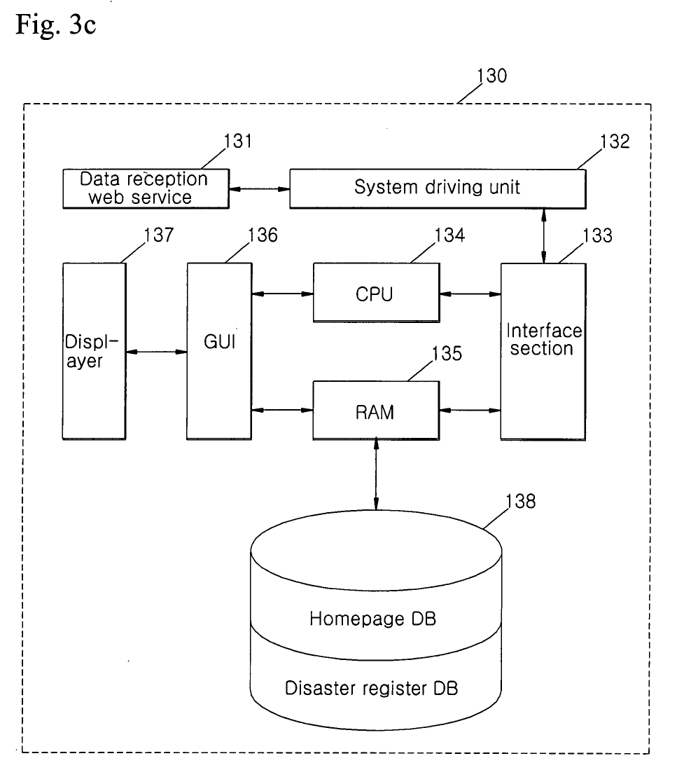

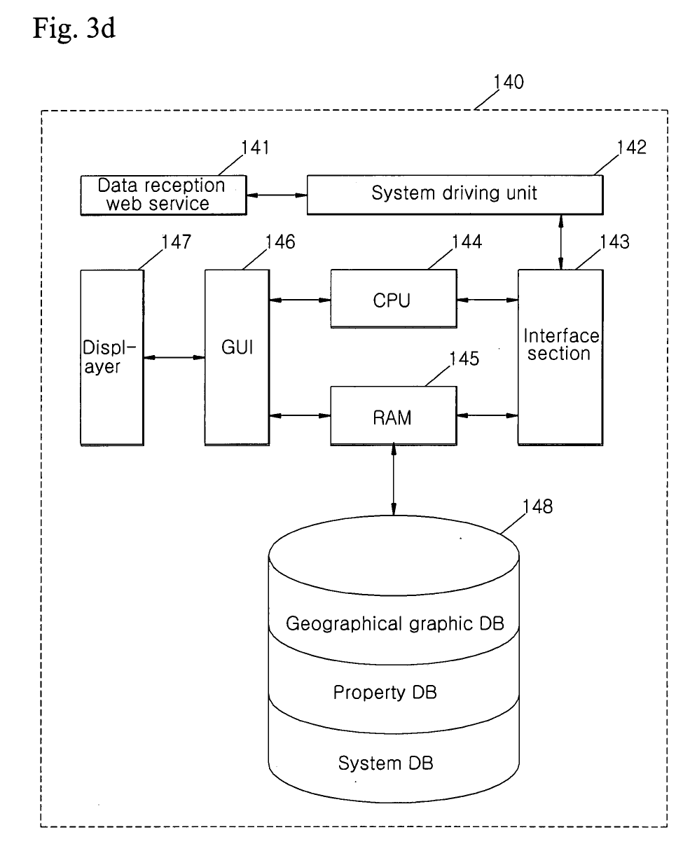

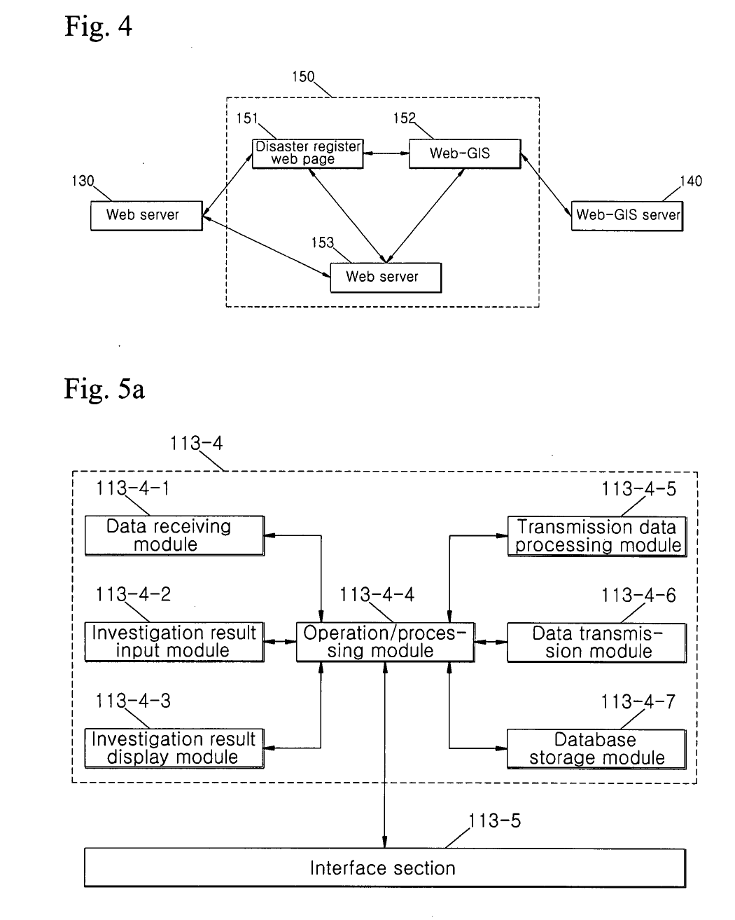

FIG. 1 is a block diagram showing the overall structure of a real time automatic update system for disaster damage investigation using wireless communication and a web-GIS according to the present invention. FIG. 2 is a detailed block diagram of the field equipment kit 110 of FIG. 1. FIG. 3A is a detailed block diagram of a portable damage investigation equipment 113 of FIG. 2. FIGS. 3B, 3C, and 3D are detailed block diagrams of a damage investigation information receiving server 120, a web server 130 and a web-GIS server 140 of FIG. 1. FIG. 4 is an illustration of the display and configuration of a web display information block 150 of FIG. 1.

Referring to FIG. 1, the real time automatic update system for disaster damage investigation according to the present invention includes a field equipment kit 110 which is comprised of various kinds of equipments for capturing the location of a damaged area, damage cause information, damage images and moving images, and voice information and transmitting them to a server, rather than being composed of one server or workstation; a damage investigation information receiving server 120 which receives data created in the field equipment kit and transmitted from the field equipment kit 110 through wireless communication, analyzes/stores disaster data, and classifies/processes the disaster data; a web server 130 which receives data classified as being required for a homepage, a disaster register, a web-GIS, etc. from the damage investigation information receiving server 120 and establishes a disaster register DB and a web DB; a web-GIS server 140 which updates and stores geographical information and geographical property information linked with the web server 130; a web display information block 150 which is linked with the web server 130 and the web-GIS server 140 and displays disaster information and geographical information in various forms on the internet; and a client terminal 160 (hereinafter, “client”) which uses the above components. Among them, the client 160 is referred to as a general computer terminal or a portable terminal capable of internet access, which may corresponds to wherever the internet is available as well as a disaster task office and a government agency. A description thereof will be omitted in the actual system configuration stage.

Referring to FIG. 2, the field equipment kit 110 of FIG. 1 is provided with a portable damage investigation equipment (Ultra-Mobile PC; UMPC) 113 which includes measuring equipments, such as a high-resolution digital camera 111, a voice recorder 112 and a portable GPS terminal 114, for preparing a scientific and objective basis for estimation of a damage scale and receives data measured in each of the measuring equipments by using WiFi communication, USB, CD, etc.; and an ultra-speed wireless internet modem 115 which transmits complete data recombined in the portable damage investigation equipment 113 from a on-site investigation group to the damage investigation information receiving server 120, which is the next stage.

At this time, the high-resolution digital camera should be the one capable of WiFi communication in order to make it easier to transmit data to the portable damage investigation equipment 113, and the voice recorder and the portable GPS terminal also should be the one capable of data transmission through a USB.

Although various kinds of devices, such as a PDA, a laptop, and a UMPC, ensuring information storing and processing can be used as the portable damage investigation equipment 113, the use of the UMPC that most ensures portability and availability is recommended. In case of the UMPC serving as the portable damage investigation equipment 113, it is embodied such that a program capable of entering data acquired from other equipments and information obtained by naked-eye measurement and direct measurement according to a given investigation item as well as the aforementioned data reception is installed therein and used. A description of this program will be concretely made later together with detailed examples.

As to the ultra-speed wireless internet modem, although a variety of practically applicable methods, such as Wibro (Wireless Broadband Internet), CDMA (Code Division Multiple Access), EVDO (EVolution Data Only), HSDPA (High Speed Downlink Packet Access), etc., are applicable thereto, the use of HSDPA is recommended, in consideration with all of speed, availability, etc.

Referring to FIGS. 3A to 3D, in the portable damage investigation equipment 113, the damage investigation information receiving server 120, the web server 130 and the web-GIS server 140, memories (hereinafter, “RAM”) 113-7, 126, 135, and 145 and, in some cases, graphic user interfaces (hereinafter, “GUI”) 113-8, 136, and 146 are electrically connected to a central processing unit (hereinafter, “CPU”) serving as a main component. DBs 113-10, 127, 138, and 148 having a plurality of DBs 113-10, 127, 138-1, 138-2, 148-1, 148-2, and 148-3 according to the present invention are electrically connected to the RAM. System driving units 113-4, 123, 132, and 142 in each step of the real time automatic update system for disaster damage investigation according to the present invention programmed so as to be compatibly operated with CPUs through interface sections 113-5, 124, 133, and 143 are electrically connected to the CPUs, and data transmitters 122 and 113-3 and data receivers 113-1, 113-2, 121, 131, and 141 for data linking by step are connected to the CPUs as well.

At this time, the system driving unit 113-4 of the portable damage investigation equipment 113 performs an overall processing operation of receiving GPS coordinates of a corresponding damaged area from a GPS server (not shown) through a Wi-Fi type data receiver 113-1 and automatically setting the same when position information of a damaged area is entered through a key input section (not shown) and a GPS coordinate setting is selected, receiving image data, moving image data and voice data of a damaged area through a USB type data receiver 113-2 and loading and outputting the same, performing an information registration processing by entering information through the key input section and linking weather data and web data, and processing corresponding information in a web document and transmitting the same to the damage investigation information receiving server 120 through a HSDPA type data transceiver 113-3.

The system driving unit 123 of the damage investigation information receiving server 120 performs an overall processing operation of analyzing corresponding data in comparison with basic disaster data when damaged area information in a web document form is received from the portable damage investigation equipment 113, storing and registering the same in the disaster DB, classifying the corresponding information into data for the web server 130 and data for the web-GIS server 140 and converting the same into a protocol of the corresponding server, and transmitting the corresponding data to the web server 130 and the web-GIS server 140.

The system driving unit 132 of the web server 130 performs the process of receiving damaged area information transmitted from the damage investigation information receiving server 120, classifying the corresponding data into data for registration in a disaster register DB and homepage data and registering them respectively, and linking the corresponding homepage information with the disaster register DB to register the same.

The system driving unit 142 of the web-GIS server 140 performs the process of receiving damaged area information transmitted from the damage investigation information receiving server 120, analyzing the corresponding data and determining whether a new layer is required or not, adding new graphic information and property information of the corresponding area if the new layer is required, configuring geographical graphic information and property information of the corresponding area as web-GIS information if the new layer is not required, and linking the same with the disaster register DB for their update.

Referring to FIG. 4, types of information to be displayed on the web according to the present invention include a disaster register web page 151, a web-GIS 152, a homepage 153 and so on, wherein a user can access and check such information whenever and wherever they want.

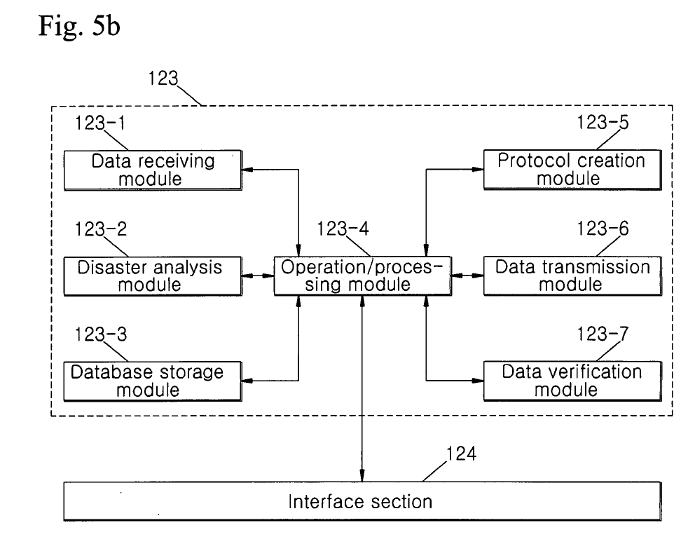

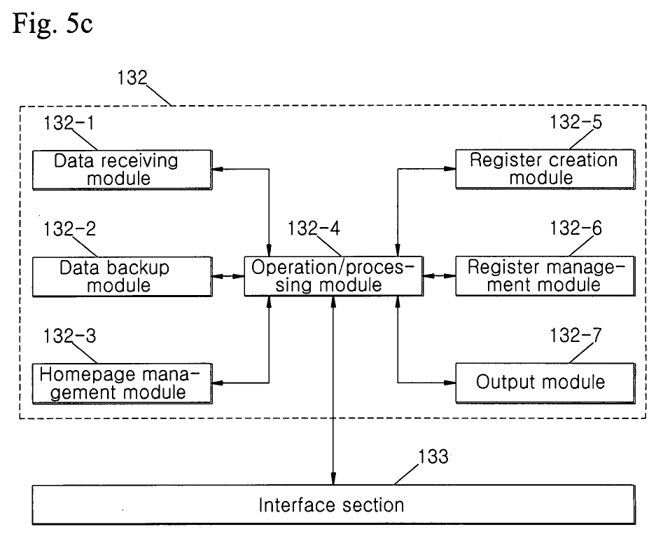

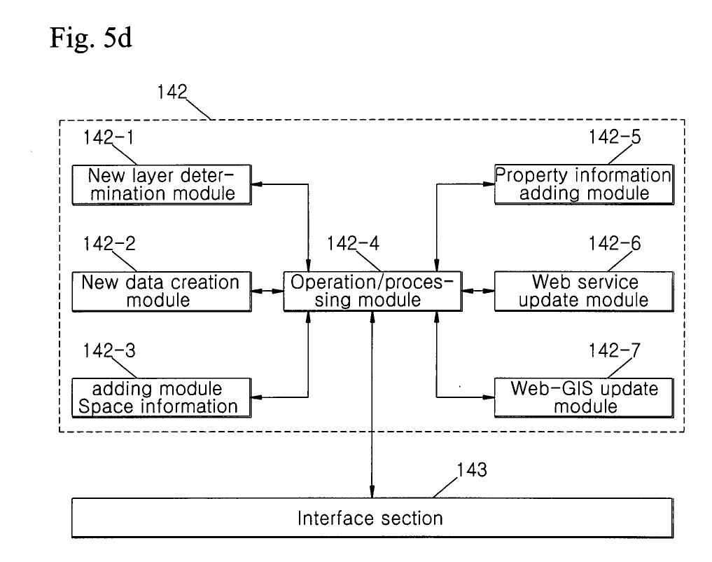

FIGS. 5A, 5B, 5C, and 5D illustrate detailed block diagrams of the system driving units of FIGS. 3A, 3B, 3C, and 3D, respectively.

Referring to FIGS. 5A and 5B, each of the system driving unit 113-4, 123, 132, and 142 in each step has a module-based architecture, and is characterized by commonly consisting of six modules, with a corresponding one of operation/processing modules 113-4, 123-4, 132-4, and 142-4 as a main component.

The system driving unit 113-4 of the portable damage investigation equipment 113 consists of a data receiving module 113-4-1, an investigation result input module 113-4-2, an investigation result display module 113-4-3, a transmission data processing module 113-4-5, a data transmission module 113-4-6, and a database storage module 113-4-7.

The system driving unit 123 of the disaster investigation information receiving server 120 consists of a data receiving module 123-1, a disaster analysis module 123-2, a database storage module 123-3, a protocol creation module 123-5, a data transmission module 123-6, and a data verification module 123-7.

The system driving unit 132 of the web server 130 consists of a data receiving module 132-1, a data backup module 132-2, a homepage management module 132-3, a register creation module 132-5, a register management module 132-6, and an output module 132-7.

The system driving unit 142 of the web-GIS server 140 consists of a new layer determination module 142-1, a new data creation module 142-2, a space information adding module 142-3, a property information adding module 142-5, a web service update module 142-6, and a web-GIS update module 142-7.

The concrete operating principles and functions of the above-mentioned components will be described in a real time automatic update method for disaster damage investigation according to the present invention.

Meanwhile, the DB sections 113-10, 127, 138, and 148 according to the present invention are divided by purpose or type depending on the contents of work of the corresponding step by step.

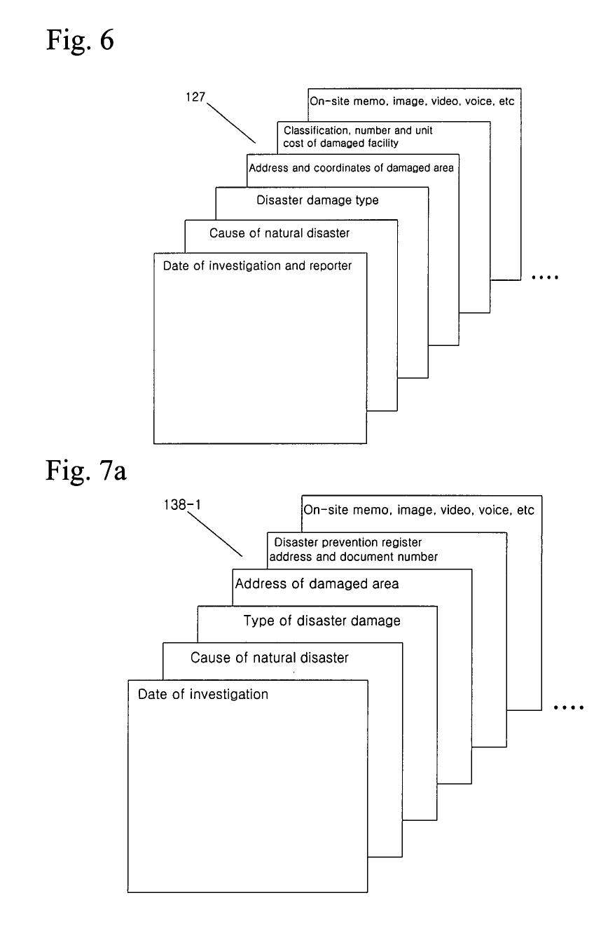

The on-site investigation DB 113-10 and the disaster investigation DB 127 are in the form of comprehensive overview of investigation results, and their data storage formats include files such as pictures, images, voice, etc. as well as texts of integer type, string type, single type and double type, and which have information as shown in FIG. 6.

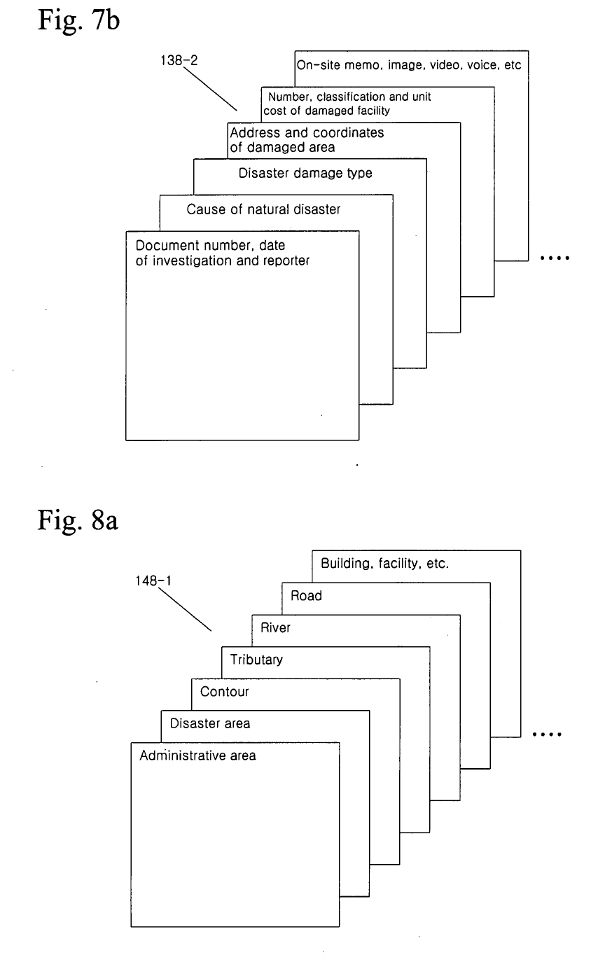

The DB section 138 of the web server 130 consists of a homepage DB 138-1 storing information to be posted on the main page and bulletin of a homepage and a disaster register DB 138-2 storing information required for drawing up a disaster register, These DBs 138-1 and 138-2 have such information as shown in FIGS. 7A and 7B.

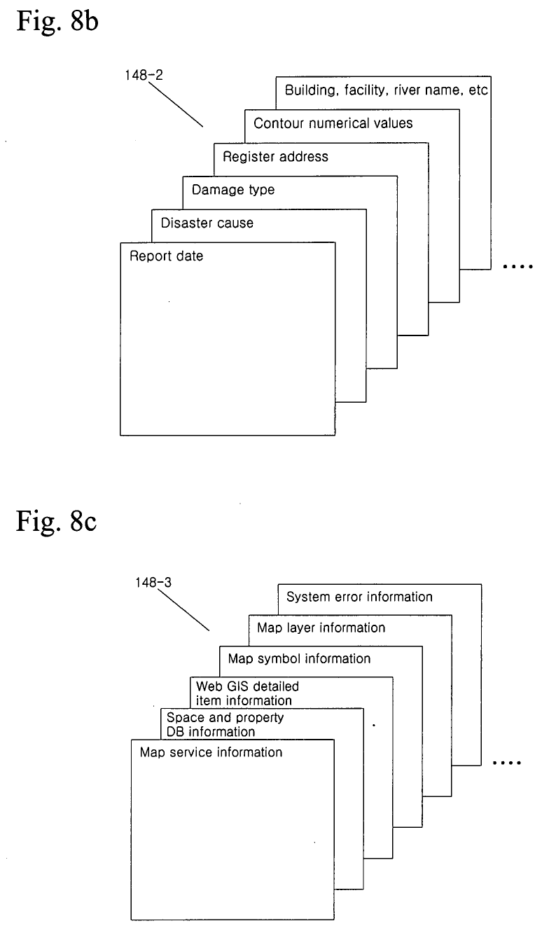

The database section 148 of the web-GIS server 140 is classified according to a data type, and consists of a geographical graphic DB 148-1 storing multiple topographic information, a property DB 148-2 storing detailed information corresponding to the topographic information and information related to disasters, and a system DB 148-3 having setting items for providing information to the system and the manager so that the system according to the present invention can be efficiently used. The above DBs 148-1, 148-2, and 148-3 have such information as shown in FIGS. 8A, 8B, and 8C.

The information stored in all of the DBs as above function and serve as basic data for properly driving the real time automatic update system for disaster damage investigation according to the present invention, and are used in processing geographical information provided in well-known geographical information systems that have been prepared and operated by government agencies and various kinds of industry-university research organizations.

More concretely, most of the above-described DBs of various types according to the present invention can specify categories listed therein and data types by way of example of actual system operation in most cases. However, the geographical graphic DB 148-1 only suggests large classification categories compressed and classified in the web-GIS actually displayed on the client terminal, and thus can be listed as in Table 1.

TABLE 1
Current status of graphic DB establishment

| No. | Classification | Subclassification | Layer shape |
|---|---|---|---|
| 1 | River | Major river | Polygon |
| 2 | River | Minor river | Line |
| 3 | River | Lake and reservoir | Polygon |
| 4 | River | Bank, tide embankment, | Line |
| | | breakwater | |
| 5 | River | Symbol | Line |
| 6 | Road | Road (large scale) | Line |
| 7 | Road | Road (medium scale) | Line |
| 8 | Road | Road (small scale) | Line |
| 9 | Road | Planned Road (large scale) | Line |
| 10 | Road | Planned Road (medium scale) | Line |
| 11 | Road | Planned Road (small scale) | Line |
| 12 | Road | Road under construction | Line |
| | | (large scale) | |
| 13 | Road | Road under construction | Line |
| | | (medium scale) | |
| 14 | Road | Road under construction | Line |
| | | (small scale) | |
| 15 | Road | Bridge | Polygon |
| 16 | Road | Facilities | Line |
| 17 | Road | Road number | Annotation |
| 18 | Building | Building border | Polygon |
| 19 | Building | Wall | Line |
| 20 | Building | Administrative building | Line |
| 21 | Building | Government investment agency | Line |
| | | building | |
| 22 | Building | Industrial, commercial and | Line |
| | | agricultural building | |
| 23 | Building | Other building | Line |
| 24 | Tributary | Tributary boundary | Line |
| 25 | Tributary | Cultivated land, landscape, forest | Line |
| 26 | Tributary | Culture, gym facility, mine, | Line |
| | | landfill | |
| 27 | Facility | Facility | Line |
| 28 | Landform | Convex land (large scale) | Polygon |
| 29 | Landform | Convex land (medium scale) | Polygon |
| 30 | Landform | Convex land (small scale) | Polygon |
| 31 | Landform | Numerical value | Annotation |
| 32 | Administrative | Administrative boundary | Line |
| | and county | | |
| | boundary | | |
| 33 | Cycle | Road | Annotation |
| 34 | Cycle | River | Annotation |
| 35 | Cycle | Building | Annotation |
| 36 | Cycle | Tributary | Annotation |
| 37 | Disaster | Typhoon | Point |
| 38 | Disaster | Typhoon heavy rain | Point |
| 39 | Disaster | Heavy rain | Point |
| 40 | Disaster | Storm | Point |
| 41 | Disaster | Rainstorm | Point |
| 42 | Disaster | Gust | Point |
| 43 | Disaster | Hail | Point |
| 44 | Disaster | Hail and thunderbolt | Point |
| 45 | Disaster | Thunderbolt | Point |
| 46 | Disaster | Tidal wave | Point |
| 47 | Disaster | Heavy snow | Point |
| 48 | Disaster | snowstorm | Point |
| 49 | Disaster | Earthquake (earthquake hail) | Point |
| 50 | Disaster | Drought | Point |
| 51 | Disaster | Volcano | Point |
| 52 | Disaster | Yellow dust (Dusty wind) | Point |
| 53 | Disaster | Others | Point |

Among the layers of the detailed category of the graphic DB of Table 1, the 1^{st} to 36^{th} general disaster information layers are extracted and processed from a 1:5000 numerical map by National Geographic Information Institute of Korea as an original copy. Although the present subclassification is divided into 36 groups, about 330 layers are grouped on the real numerical map according to the similarity of contents and shapes.

The result to be actually displayed on the web-GIS does not provide all the layers listed above. Although an explanation of the web-GIS will be made later in detail, it should be noted that the layers are displayed according to the user's selection and sub-layers are graded so that only required information is automatically determined and displayed according to an expansion scale. Display grades of the sub-layers are as shown in Table 2.

TABLE 2
Display Grades of Sub-layers of Graphic DB

| | | | Display |
|---|---|---|---|
| No. | Classification | Subclassification | grade |
| 1 | River | Major river | Large |
| 2 | River | Minor river | Medium |
| 3 | River | Lake and reservoir | Large |
| 4 | River | Bank, tide embankment, breakwater | Medium |
| 5 | River | Symbol | Small |
| 6 | Road | Road (large scale) | Large |
| 7 | Road | Road (medium scale) | Medium |
| 8 | Road | Road (small scale) | Small |
| 9 | Road | Planned Road (large scale) | Large |
| 10 | Road | Planned Road (medium scale) | Medium |
| 11 | Road | Planned Road (small scale) | Small |
| 12 | Road | Road under construction (large scale) | Large |
| 13 | Road | Road under construction (medium scale) | Medium |
| 14 | Road | Road under construction (small scale) | Small |
| 15 | Road | Bridge | Medium |
| 16 | Road | Facilities | Small |
| 17 | Road | Road number | Small |
| 18 | Building | Building border | Medium |
| 19 | Building | Wall | Small |
| 20 | Building | Administrative building | Small |
| 21 | Building | Government investment agency building | Small |
| 22 | Building | Industrial, commercial and agricultural | Small |
| | | building | |
| 23 | Building | Other building | Small |
| 24 | Tributary | Tributary boundary | Medium |
| 25 | Tributary | Cultivated land, landscape, forest | small |
| 26 | Tributary | Culture, gym facility, mine, landfill | Small |
| 27 | Facility | Facility | Small |
| 28 | Landform | Convex land (large scale) | Large |
| 29 | Landform | Convex land (medium scale) | Medium |
| 30 | Landform | Convex land (small scale) | Small |
| 31 | Landform | Numerical value | Small |
| 32 | Administrative | Administrative boundary | Large |
| | and county | | |
| | boundary | | |
| 33 | Cycle | Road | Small |
| 34 | Cycle | River | Small |
| 35 | Cycle | Building | Small |
| 36 | Cycle | Tributary | Small |
| 37 | Disaster | Typhoon | Large |
| 38 | Disaster | Typhoon heavy rain | Large |
| 39 | Disaster | Heavy rain | Large |
| 40 | Disaster | Storm | Large |
| 41 | Disaster | Rainstorm | Large |
| 42 | Disaster | Gust | Large |
| 43 | Disaster | Hail | Large |
| 44 | Disaster | Hail and thunderbolt | Large |
| 45 | Disaster | Thunderbolt | Large |
| 46 | Disaster | Tidal wave | Large |
| 47 | Disaster | Heavy snow | Large |
| 48 | Disaster | Snowstorm | Large |
| 49 | Disaster | Earthquake (earthquake hail) | Large |
| 50 | Disaster | Drought | Large |
| 51 | Disaster | Volcano | Large |
| 52 | Disaster | Yellow dust (Dusty wind) | Large |
| 53 | Disaster | Others | Large |

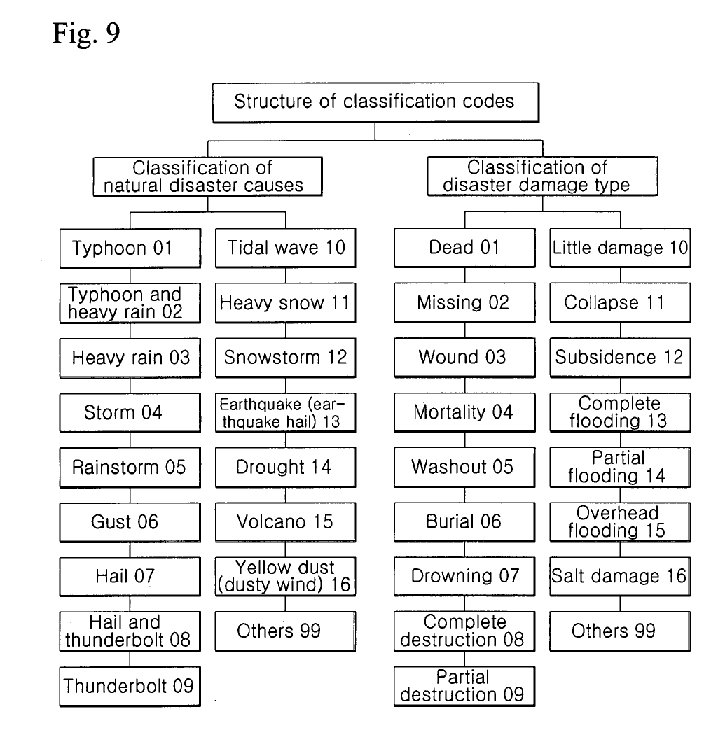

In the present real time automatic update system for disaster damage investigation, damaged areas are classified by using natural disaster cause classification and disaster damage type classification in the code standardization system of the Ministry of Government Administration and Home Affairs of Korea, and those as shown in FIG. 9 are set up as the subcategories of each classification. That is, a corresponding disaster damage investigation case can be classified according to a natural disaster cause, which becomes the standard of classification of disaster layers on the web-GIS as well as simple classification of cases. The subcategories are represented by a total of 17 categories, including typhoon, heavy rain, hail, thunderbolt, tidal wave, heavy snow, earthquake, drought, volcano, yellow dust, and combinations of them, and include even natural disasters, such as tidal wave and volcano, which do not occur frequently within the country but cause a big damage or which may cause a big damage in foreign countries, as well as actually frequently occurring natural disasters. The classification of disaster damage types also includes all the categories that may cause human damage and various kinds of economic damage as described above. The disaster damage types are classified to such an extent as to judge the seriousness of damage, for example, as mortality, washout, burial, drowning, complete destruction, partial destruction, little damage, collapse, subsidence, overhead flooding, salt damage, etc., as well as dead, missing and wounded, which are expressed as a total of 17 categories including others.

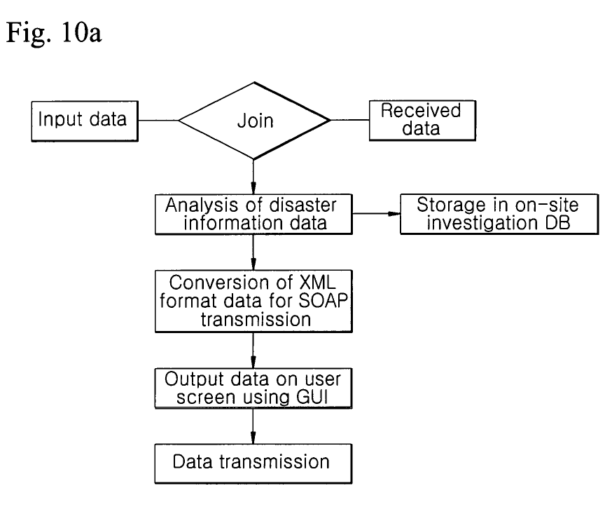

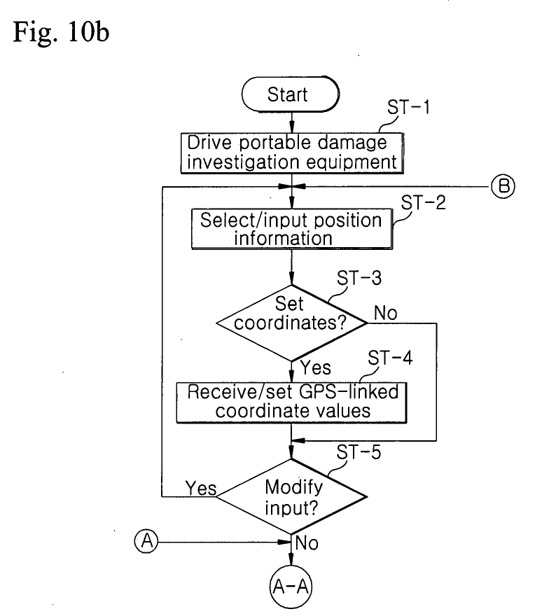

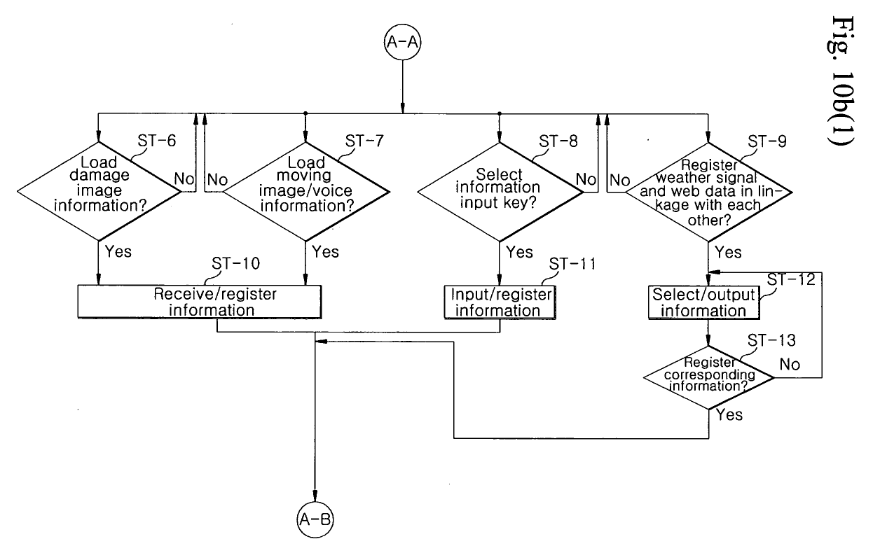

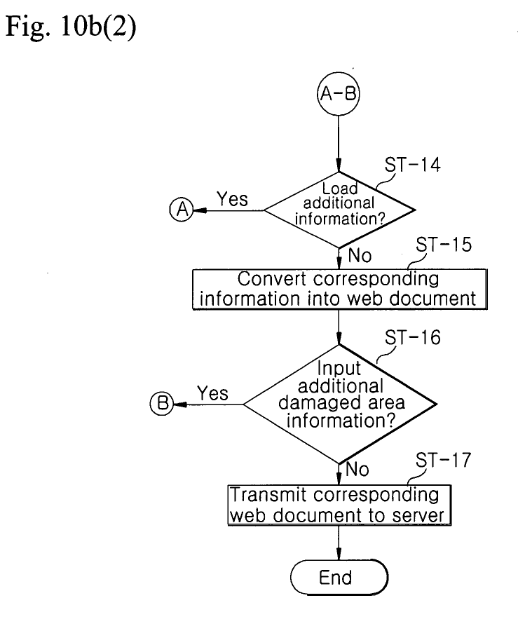

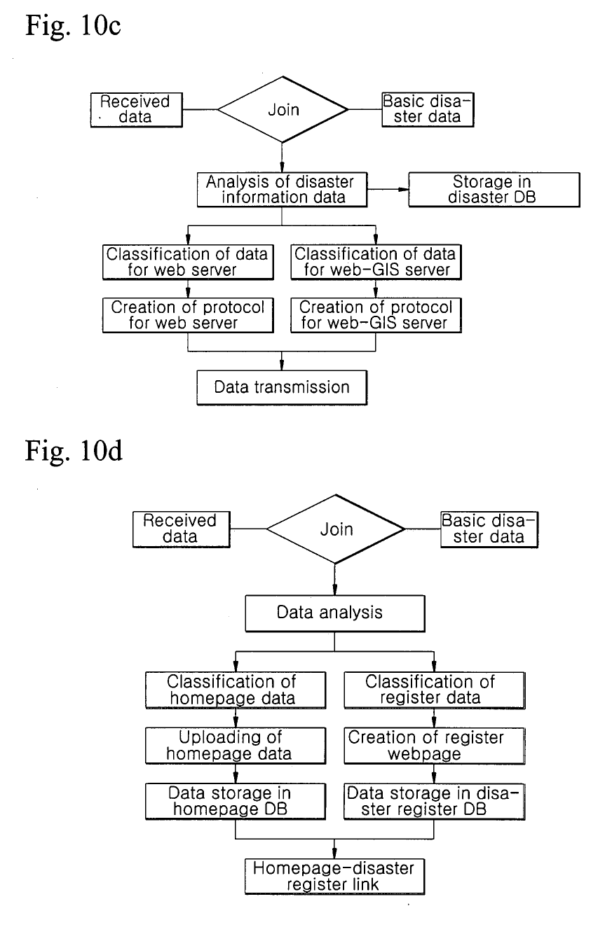

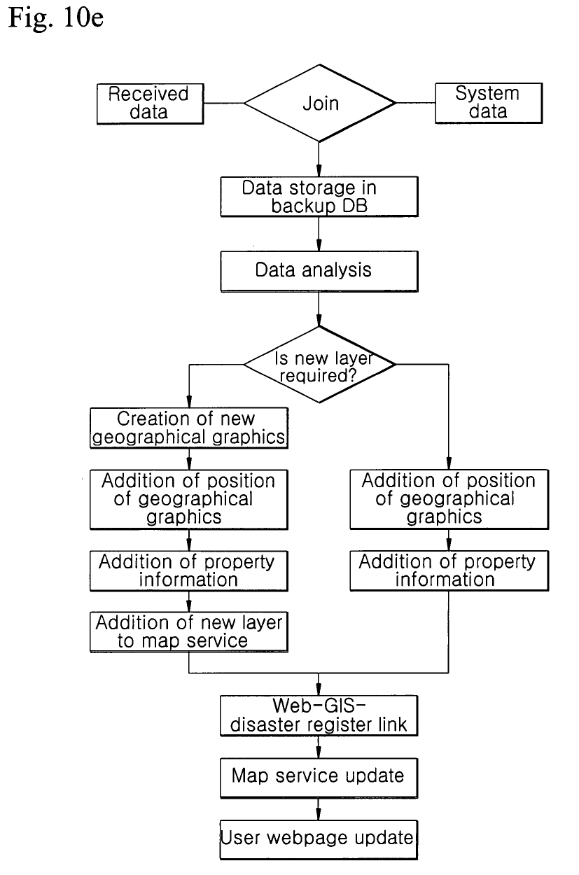

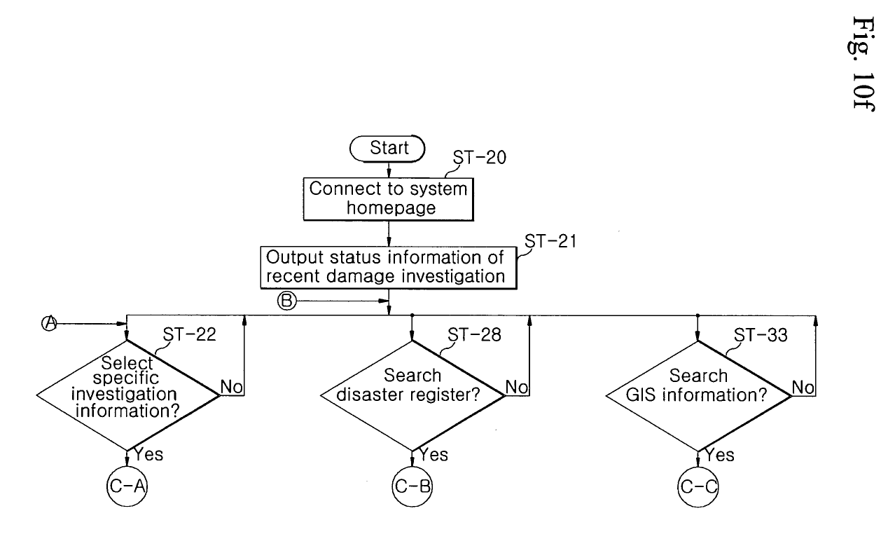

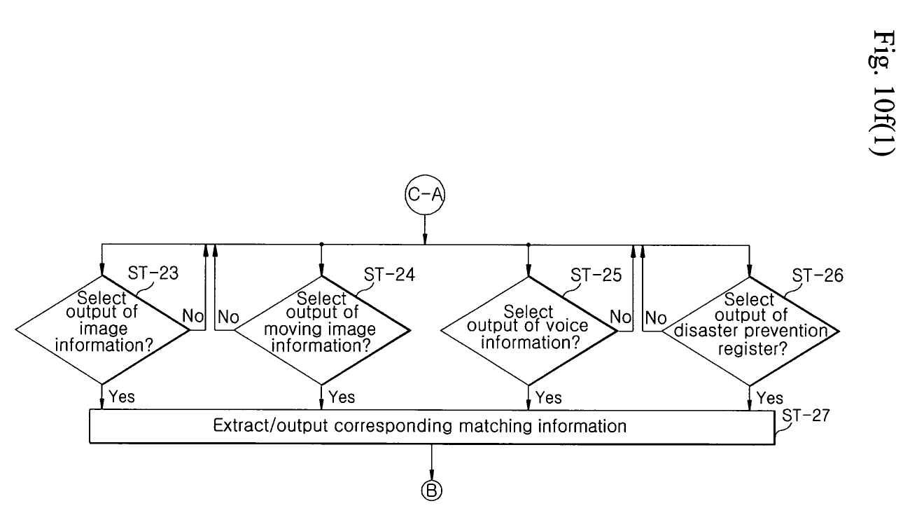

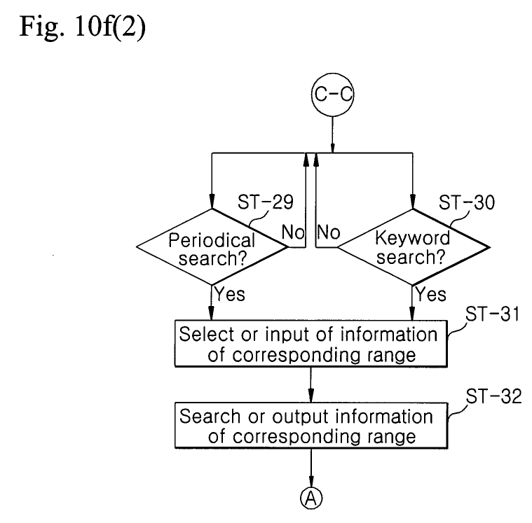

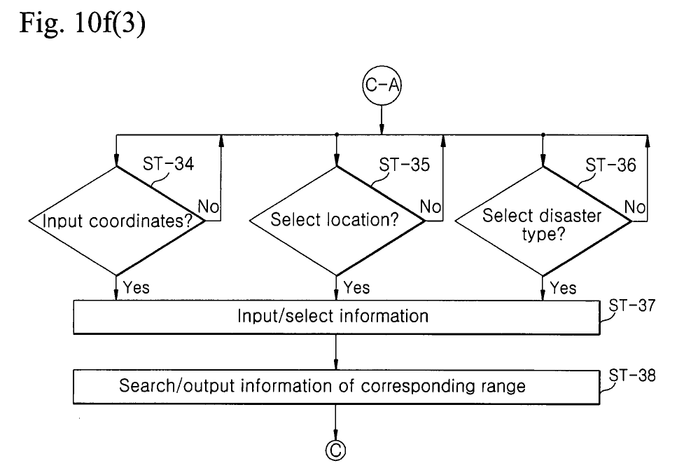

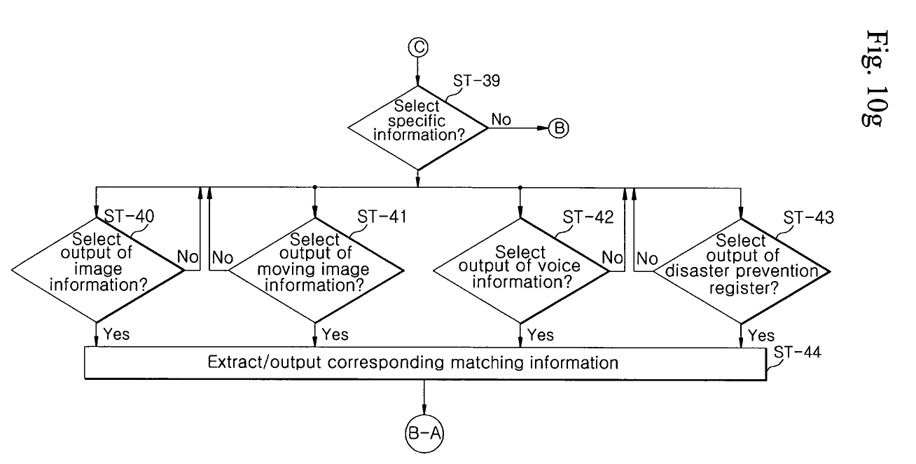

FIGS. 10A, 10B, 10C, 10D, and 10E work flow charts showing the process in which data is received by the portable damage investigation equipment 113, the damage investigation information receiving server 120, the web server 130, and the web-GIS server 140 and sent to the next step or displayed as web display information.

Referring to these drawings, the portable damage investigation equipment 113 analyzes data related to disaster damage, which is integrated by joining data received from various equipments and data inputted by the user, and stores the same in the on-site investigation DB so as to prevent data loss and search and display inputted data later. Apart from this, the portable damage investigation equipment 113 converts data entered in an XML format for SOAP (Simple Object Access Protocol) type data transmission to the damage investigation information receiving server 120 in the next step, outputs the result and stored detailed data on the user screen by using a GUI, and sends completed data.

Referring to FIG. 10B, an information registration process using the portable damage investigation equipment 113 will be described in more detail. When the portable damage investigation equipment 113 is driven according to the user's input and selection and position information of a damaged area is inputted into the system driving unit 113-4, the system driving unit 113-4 determines whether a coordinate setting key is inputted (ST-1, ST-2 and ST-3).

If the coordinate setting key is inputted, the system driving unit 113-4 transmits a positioning request signal to a remote GPS server (not shown), and thereafter receives coordinate values from the corresponding GPS server and automatically sets the same (ST-4).

In this state, the system driving unit 113-4 determines whether a key signal for input correction is applied, and if the input correction key is applied, the procedure returns to the second step.

If the input correction key is not applied, the system driving unit 113-4 determines whether a damage image information loading signal is applied through additional equipments such as a digital camera, a voice recorder and a key input section, wireless ultra-speed communication equipment and so on (ST-6), whether a moving image/voice information loading signal is applied through the additional equipments (ST-7), whether an input signal of other information such as memos about the corresponding damaged area information is applied through the additional equipments (ST-8), and whether a loading signal of weather data and other web data of the corresponding area is applied through the additional equipments over the wireless internet network (ST-9).

If damage image information or a moving image/voice information loading signal is applied from a digital camera or a voice recorder through a USB port, the system driving unit 113-4 receives the corresponding information and registers the same in the on-site investigation DB 113-10 (ST-10).

Additionally, if an input signal of other information such as memos about the corresponding damaged area information is applied through the key input section, text information inputted along with image/moving image/voice data of the corresponding damaged area is linked and registered in the on-site investigation DB 113-10 (ST-11).

Further, if a loading signal of weather data and other web data of the corresponding area is applied through the wireless internet, the system driving unit 113-4 receives the corresponding information and outputs it on the screen (ST-12), and determines whether a registration signal for the corresponding information is applied, to link the same with the image/moving image/voice/text data of the corresponding damaged area and register the same in the on-site investigation DB 113-10 (ST-13).

In this state, the system driving unit 113-4 determines whether an additional information loading signal is applied, and the procedure returns to steps ST-6, ST-7, ST-8, and ST-9 via tap A if the additional information loading signal is applied, or converts and process the corresponding information into a web document if it is not applied (ST-14 and ST-15).

Next, the system driving unit 113-4 determines whether an information input signal of an additional damaged area is applied (ST-16), and the procedure returns to step ST-2 via tap B if an additional damaged area information input signal is applied, or transmits the corresponding information to the damage investigation information receiving server 120 through the HSDPA type data transceiver 113-3 if it is not applied.

Referring to FIG. 10C, the damage investigation information receiving server 120 receives data transmitted from the portable damage investigation equipment, joins the same to basic disaster data prestored therein, analyzes the joined integrated disaster information data and stores the same in the disaster DB, divides it into data for the web server and data for the web-GIS server according to the result of analysis, subdivides each data according to a required format, and creates the same into a protocol format specified for data transmission to each server. The created protocol also sends data to each server in a SOAP type XML format.

Referring to FIG. 10D, the web server 130 receives data transmitted from the damage investigation information receiving server 120, joins the same to basic disaster data prestored therein, analyzes the joined integrated disaster information data to divide the same into data for homepage posting and data for disaster register creation, subdivides each data into subcategories, uploads results classified by category on the homepage and utilizes the same in the creation of the disaster register webpage, stores each data in the homepage DB and the disaster register DB 138-2, and links finally created homepage posts and its corresponding disaster register with each other.

Referring to FIG. 10E, the web-GIS server 140 receives data transmitted from the damage investigation information receiving server 120, joins the same to system data prestored therein, basically stores the joined data in the backup DB, and analyzes the integrated data. After the analysis, classification is made depending on whether a disaster is caused by new factors according to natural disaster cause codes to search if a new layer is required. If the new layer is required, a blank geographical graphic is newly created, corresponding coordinate points are added to the created geographical graphic, the property information is inputted, and then the new layer is added to a map service in order to apply the created geographical graphic to the web-GIS. On the other hand, if the new layer is not required, the existing geographical graphics are opened, a disaster location corresponding to received coordinates is added, the property information is inputted, and then the procedure goes to the next step. In the next step, the points added to the web-GIS and their corresponding disaster register webpages are linked and the process of updating the map service is performed so that an update result can be applied to the map service of the web-GIS that is to be displayed to the user, and finally the webpages, such as the internet explorer, being displayed to the user are updated so as to check new data.

The ArcIMS 8.3 version provided by ESRI Inc. is used for the web-GIS, the ArcGIS Engine 9.1 version or MapObject 2.3 version of the same company is used for addition of geographical graphics, and a JAVA component provided in the installation of ArcIMS and an XML for controlling the same are created for updating the map service of ArcIMS. In order to automatically perform the entire process, a Batch file is created such that it can be executed and updated at an appropriate time when the system driving unit of the web-GIS server performs the update process.

The real time automatic update system for disaster damage investigation according to the present invention having the above-described features expresses a result by such an analysis process as shown in FIGS. 10A to 10E. Data items are analyzed by using the system established from the aforementioned on-site investigation DB 113-10, the disaster investigation DB 127, the homepage DB 138-1, the disaster register DB 138-2, the geographical graphic DB 148-1, the property DB 148-2 and the system DB 148-3, and the analyzed data items are classified, updated in each display form and outputted through displayers 113-9, 137, and 147 according to the user's request. Outputs through the above displayers are done by the GUIs 113-8, 136, and 146.

Meanwhile, in the real time automatic update system for disaster damage investigation using wireless communication and a web-GIS according to one embodiment of the present invention, the user can browse disaster information, which is registered in the web server 130 and the web-GIS server 140 by the damage investigation information receiving server 120, through the client terminal 160.

Referring to FIGS. 10F and 10G, the user connects to the web server 130 having a variety of disaster-related information posted on the homepage by using the client terminal 160. The web server 130 outputs recent damage investigation status information on the initial main screen. The web server 130 determines whether a selection signal of any one of the corresponding recent damage investigation status information is applied from the client terminal 160 (ST-20 and ST-21).

Each of the recent damage investigation status information is posted on the web server 130 such that image information, moving image information, voice information, and a disaster prevention register can be outputted or browsable by each type of information. When a selection signal for specific investigation information is applied, the web server 130 determines whether the selection signal is the one for image information, moving image information, voice information and disaster prevention register of the corresponding investigation information, applied from the client terminal 160 (ST-22, ST-23, ST-24, ST-25, and ST-26).

If the selection signal for any one of the information is applied, the web server 130 extracts the information corresponding to the selection signal, among the image information, moving image information, voice information and disaster prevention register of the corresponding investigation information, and outputs the same (ST-27).

If the web server 130 receives a disaster register search signal from the client terminal 160 (ST-28), it determines which key signal is inputted between a period search and a keyword search from the client terminal 160, and then extracts and outputs information of the range matching with the corresponding period or keyword (ST-29, ST-30, ST-31, and ST-32).

Meanwhile, the web server 130 is linked to the web-GIS server 140, and determines whether a GIS information search signal linked to the main page of the web server 130 is applied from the client terminal 160 (ST-33).

If the web server 130 receives a GIS information search signal from the client terminal 160, it drives the web-GIS server 140, wherein the web-GIS server 140 determines whether a coordinate input signal, a position selection signal or a disaster type selection signal is applied from the client terminal 160 through the web server 130, and receives the corresponding information or a selection signal (ST-34, ST-35, ST-36, and ST-37).

In this state, the web-server 140 extracts an information code classified as a coordinate, position information, or disaster type that is inputted or selected from the client terminal 160, and transmits the information code to the web server 130. Then, the web server 130 extracts and outputs disaster information matching with the corresponding information code by using the corresponding information code (ST-38).

Based on this, the web server 130 and the web-GIS 140 are linked to each other to provide geographical graphic information and property information of the corresponding geographical information to the user, and at the same time extract disaster information preclassified by each type of geographical information through the web server 130 to provide them to the user, whereby it is possible to quickly search disaster information and find out common points by geographical information or disaster type, thereby establishing disaster recurrence prevention measures and precautionary measures.

If there is at least one information searched and outputted by the web server 130, the web server 130 determines whether a selection signal of any one information is applied from the client terminal 160 (ST-39).

Each of the recent damage investigation status information is posted on the web server 130 such that image information, moving image information, voice information, and a disaster prevention register can be outputted or browsable by each type of information. When a selection signal for a specific investigation information is applied, the web server 130 determines whether the selection signal is the one for image information, moving image information, voice information and disaster prevention register of the corresponding investigation information, applied from the client terminal 160 (ST-40, ST-41, ST-42, and ST-43)

If the selection signal for any one of the information is applied, the web server 130 extracts the information corresponding to the selection signal, among the image information, moving image information, voice information and disaster prevention register of the corresponding investigation information, and outputs the same (ST-44).

Thereafter, the web server 130 determines whether a key signal related to geographical information, such as a zoom-in signal or zoom-out signal of a corresponding area, a coordinate movement signal, and a distance measurement signal, is generated from the client terminal 160, and transmits the key signal to the web-GIS server 140 if the key signal related to the corresponding geographical information is applied (ST-45, ST-46, ST-47, and ST-48).

Then, the web-GIS server 140 extracts information on the expansion (or reduction) of the coverage of an area by GIS analysis, modifies the corresponding graphic information, and outputs the graphic information within the corresponding area coverage (ST-49 and ST-50).

If a coordinate movement signal is applied, the web-GIS server 140 applies a new coordinate by GIS analysis, modifies graphic information, and outputs the corresponding graphic information (ST-51 and ST-50). At this time, if it is necessary to register a new layer in the disaster register, new layer information and property information are additionally registered as shown in FIG. 10E.

Further, if a distance measurement signal is applied, the web-GIS server 140 receives a distance designation signal to calculate the corresponding distance and output the calculated value (ST-52 and ST-53).

In this state, the web-GIS server 140 determines whether a new input signal of GIS information is applied. If an input signal of new information is inputted, the procedure returns to step ST-45, ST-46, ST-47, or ST-48 via tap D, and if the new input signal is applied, it is determined whether a corresponding system termination signal is applied or not (ST-54 and ST-55).

If the system termination signal is not applied, the procedure returns to steps ST-22, ST-28, and ST-33 via tap B to re-execute the search for disaster information.

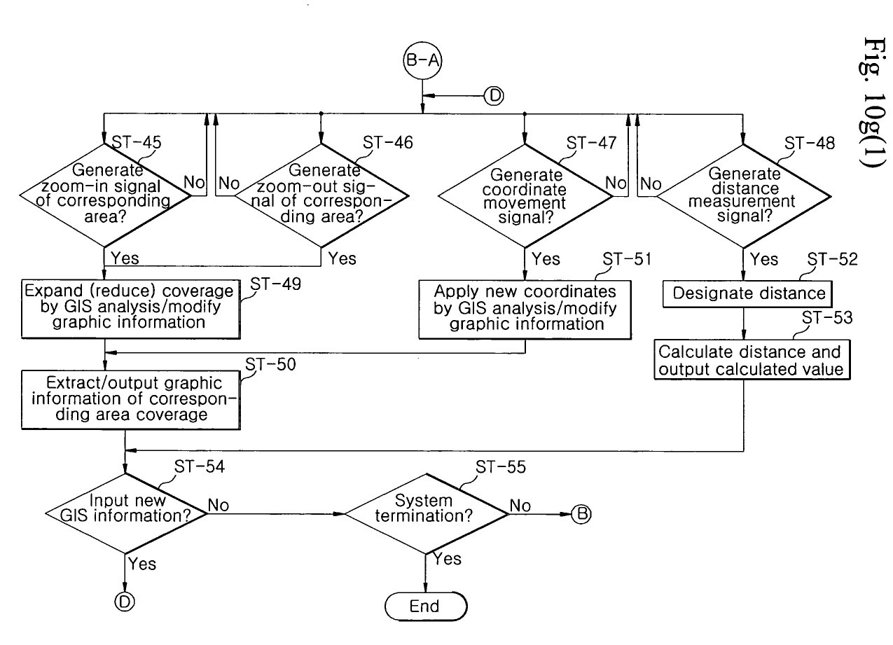

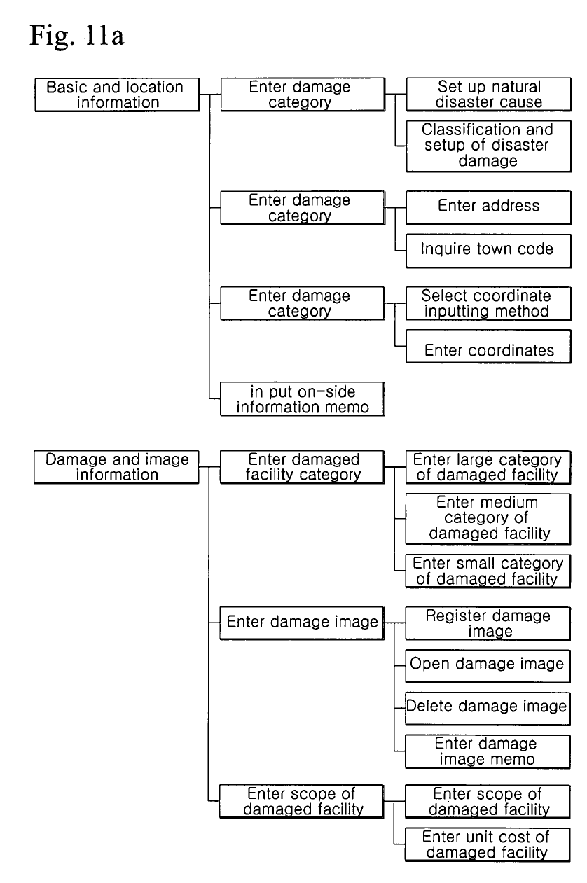

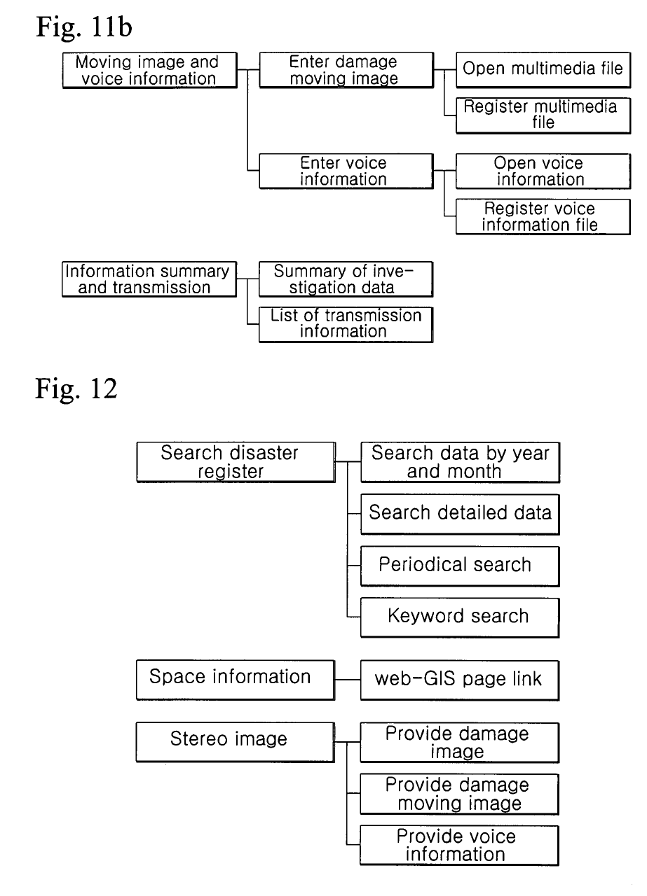

Hereinafter, a preferred real time automatic update method for disaster damage investigation according to the present invention and its embodiment will be described in detail with reference to the accompanying FIGS. 11 to 21. Further, as described above, the functional features of each component of the system according to the present invention will be described more concretely together with the present embodiment.

FIG. 11 shows a menu map of a program embedded in the portable damage investigation equipment 113 of FIG. 2 in the entire system according to the present invention. Referring to FIG. 12, the program for inputting an investigation result from an on-site investigation group has large category menu tabs and their subcategories.

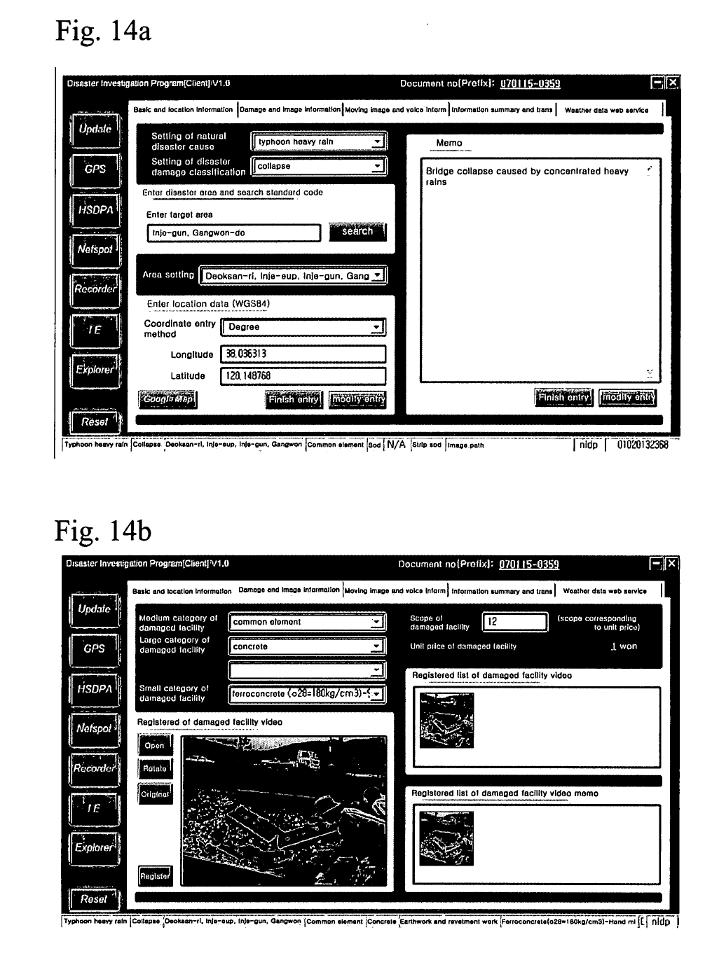

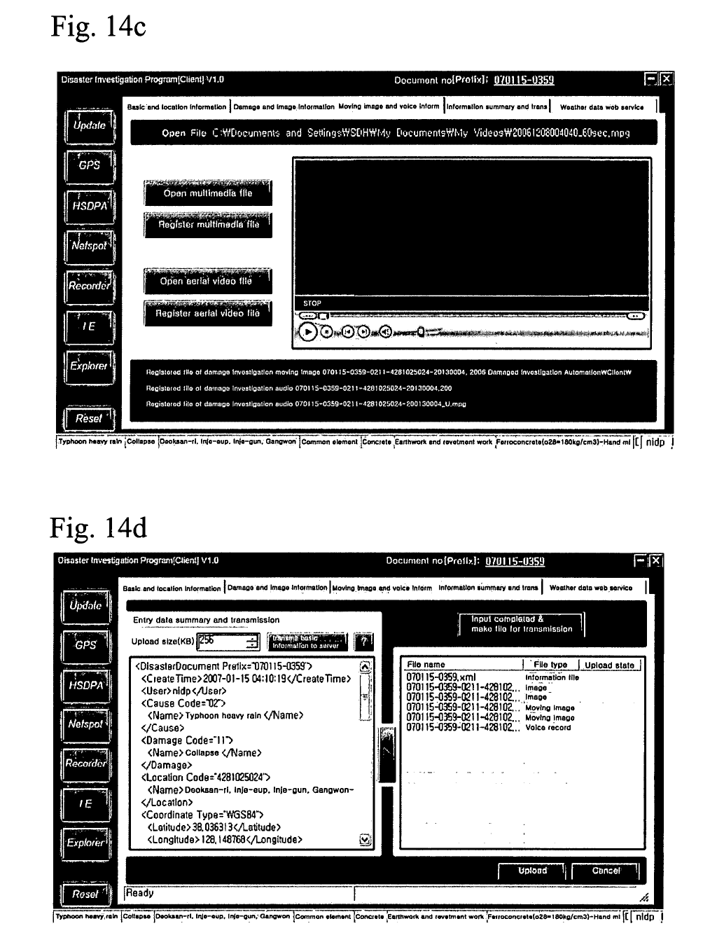

When the damage investigation result entry program stored in the portable damage investigation equipment 113 is driven, the screens of each tab as shown in FIGS. 14A, 14B, 14C, and 14D are outputted through the GUI 113-8.

FIG. 14A is a basic and location information tab for entering a natural disaster cause, a disaster damage classification, an area, a coordinate, a memo, etc.

FIG. 14B is a damage and image information tab for entering large, medium and small categories of a damaged facility, the scope of a damaged facility, a unit cost, a damaged facility image, a memo, etc.

FIG. 14C is a moving image and voice information tab for registering and reproducing a photographed multimedia moving image file, aviation image, voice, etc.

FIG. 14D is for checking information related to transmission, such as a result of creation of a message of an XML format created based on inputted information, an upload size, a file list of images transmitted together with an XML message, etc.

FIG. 12 is a menu map in which the menus and functions of the homepage 153 of the web display information block 150 in the entire system according to the present invention are listed by category.

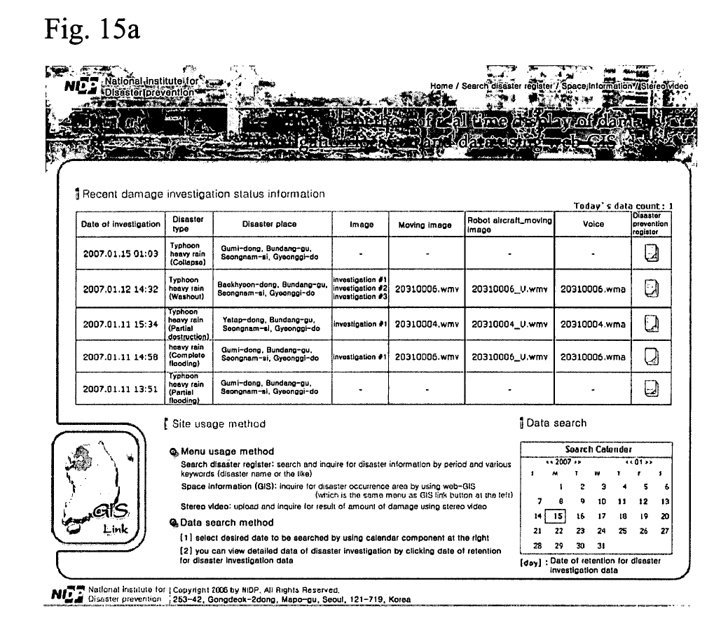

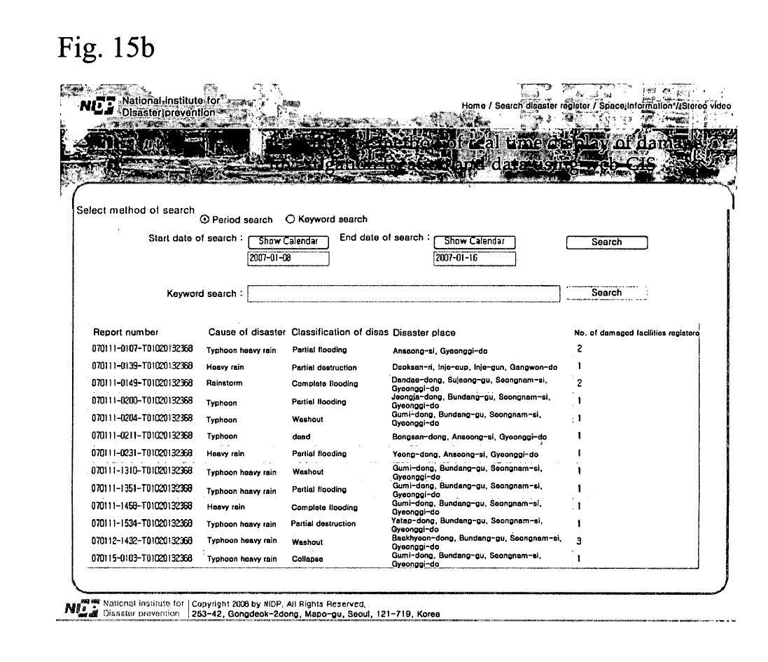

When the client terminal connects to the homepage through a general internet search engine whenever and wherever by using various kinds of equipments, the initial screen as shown in FIG. 15A is outputted, which shows an updated investigation result in a table form, and provides the function of connecting to a data search function using a web-GIS displayable part, a calendar, etc. on the lower end. The categories of the updated disaster information table include an investigation date, damage type, damaged area, image information, moving image information, uninhabited aerial vehicle moving image information, voice information, information linkable to the disaster prevention register of a corresponding disaster and the like.

The data search function in the homepage outputs the screen as shown in FIG. 15B, which provides the function of searching by period or keyword and displays a search result together with detailed item information such as a report number, disaster cause, damage type, damaged area, number of damaged facilities registered, etc. on the lower end.

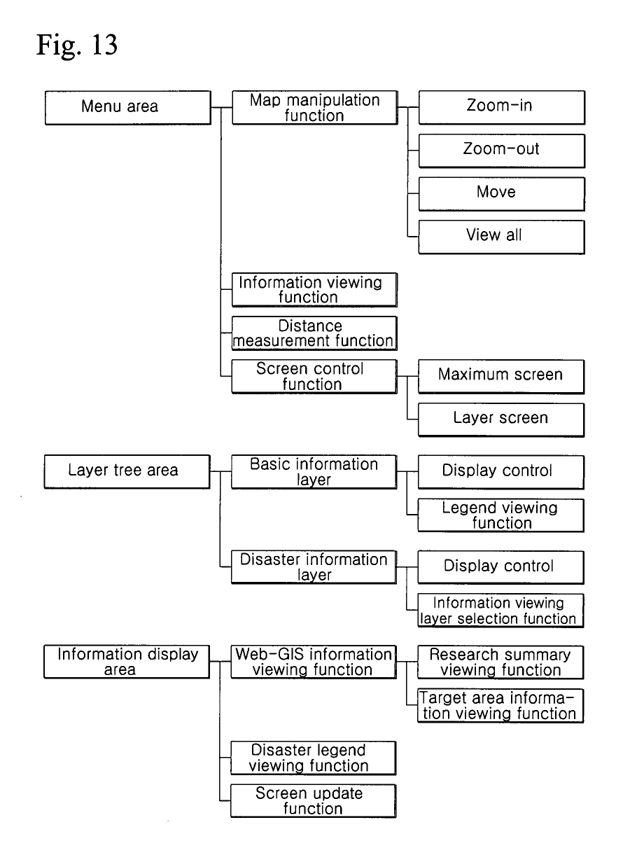

FIG. 13 is a menu map in which the functions provided by area of the web-GIS 152 of the web display information block 150 in the entire system according to the present invention are listed.

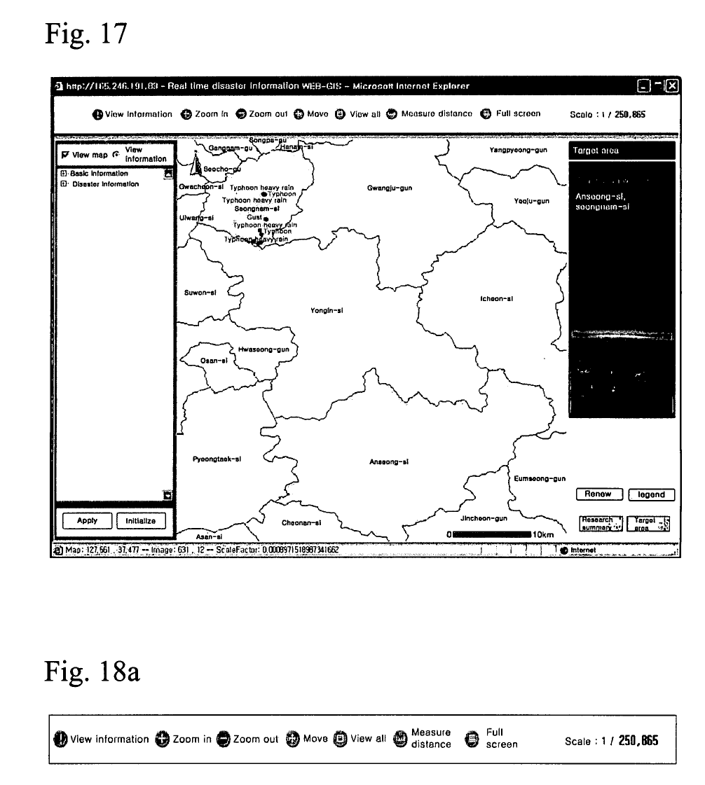

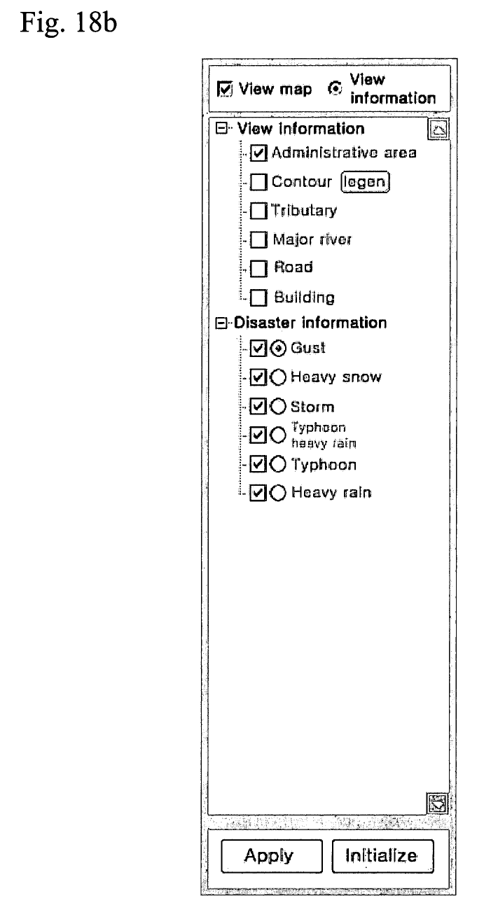

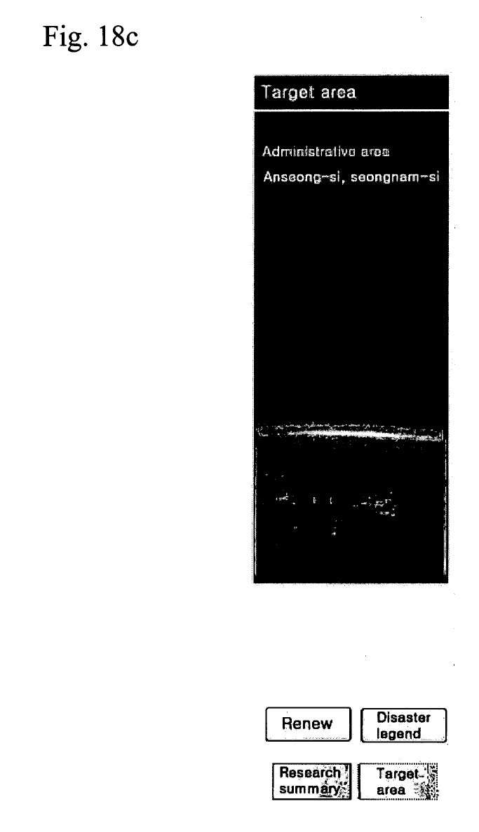

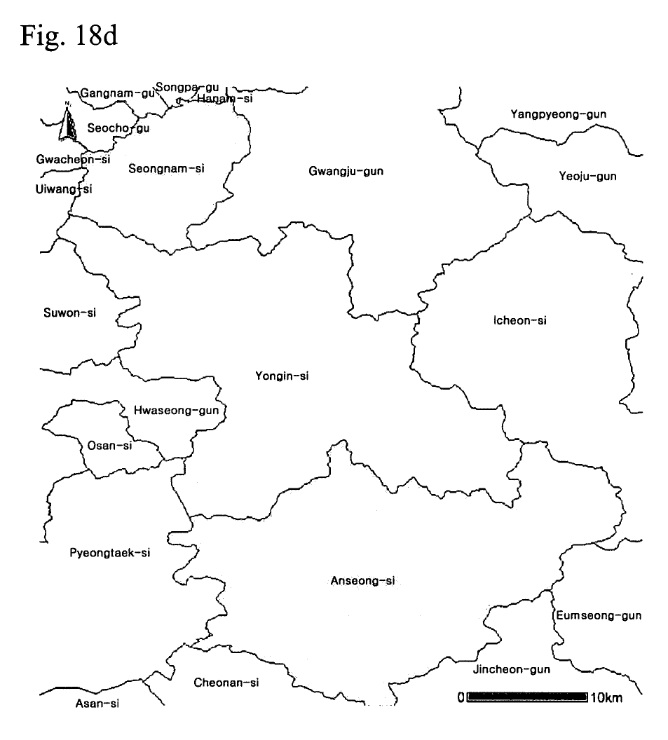

Like the homepage, when the client terminal freely connects to the homepage through an internet search engine by using various kinds of equipments to execute the page linked to the web-GIS or directly connect to the web-GIS address, the initial screen as shown in FIG. 17 is outputted, which can be divided into a menu area as shown in FIG. 18A on the upper end, a layer tree area as shown in FIG. 18B on the left side, an information display area as shown in FIG. 18C on the right side, and a map frame area as shown in FIG. 18D on the center.

In FIG. 18A, the menu area provides a View Information function allowing to link to and check the disaster register of a damaged area, a Zoom-in function for zooming in the screen to a user-designated range or predetermined ratio range, a Zoom-out function for zooming out the screen, a Move function for moving a displayed area while maintaining a display range, a View All function for zooming out a displayed area of the map frame to the entire range as in an initial state, a Measure Distance function for allowing a user to display predetermined points on the screen to measure the actual distance between the points, a Maximize Screen function for maximizing the map frame area by hiding the left layer tree area, a Display Layer function for displaying the layer tree area again and so on.

In FIG. 18B, the layer tree area is largely classified into a basic information layer and a disaster information layer, and these layers are again classified into layers of administrative area, contour, tributary, major river, road, and building and layers of natural disaster causes having current data. In the illustration of FIG. 18B, data on gust, heavy snow, typhoon heavy rain, typhoon, heavy rain, etc. are added. The order of these layers is configured in the same way as the order of added layers. When a left checkbox (square) is checked, the corresponding layer is displayed, and when a radio box (circle) is checked, the disaster register information of the checked layer is displayed through the View Information function of the menu area.

In FIG. 18C, the information display area provides the refresh function for displaying information on research summary and target area and updating the entire web pages and the disaster legend function for displaying the legend of disaster type classification. When the legend button at the right of the contour layer of FIG. 18B is selected, the contour legend is also displayed on the information display area.

In FIG. 18D, the map frame area displays geographical space information of a layer selected in the layer tree area, and the menu area provides a space for conducting a variety of user's operations when a function is executed in the menu area.

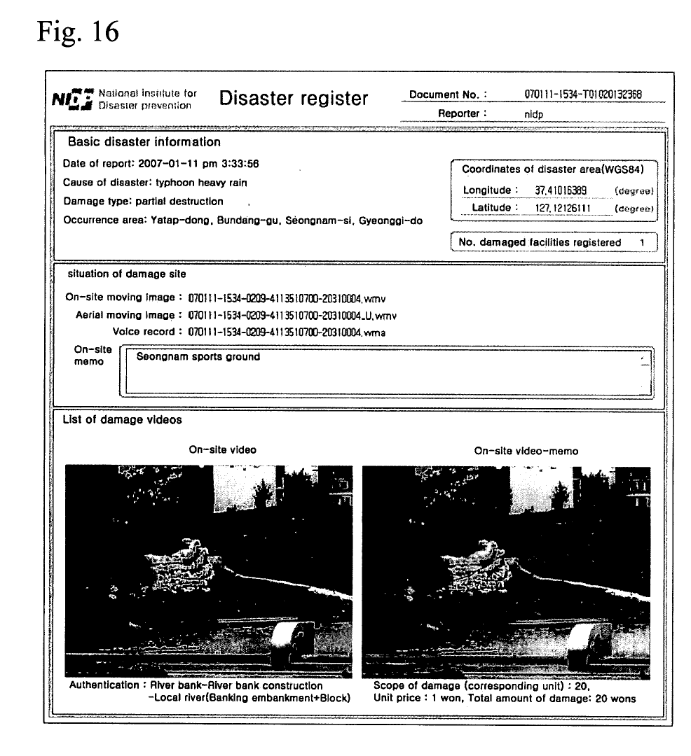

Among the user display items corresponding to the web display information block 150, the disaster register webpage 151, except for the web-GIS 152 and the homepage 153, can be displayed in linkage with the disaster list of the homepage and the information display list of the web-GIS, wherein an illustrative display screen is as shown in FIG. 16.

Referring to FIG. 16, the information provided in the disaster register largely includes document-related information, basic disaster information, situation of a damage site, damage image list, etc.

The document-related information is not for the purpose of providing information to the user but basic information related to a document, which displays a document number code and a reporter name or ID.

The basic disaster information displays a report date, disaster cause, damage type, disaster occurrence area, coordinates of a damaged area, number of registered damage facilities, etc. As the coordinates of a damaged area, WGS84 is mainly used, wherein the coordinates can be divided into latitude and altitude.

The situation of a damaged site provides visual and auditory information permitting to feel an on-site situation lively without directly going to the site by providing not simple text information, such as on-site moving images, aviation moving images, voice recordings, on-site memos, etc., but integrated information using multimedia.

The damage image list provides pictures photographed on site and explanation of the pictures, memos directly entered in the pictures, and information such as the extent of damage, a unit cost and the total amount of damage.

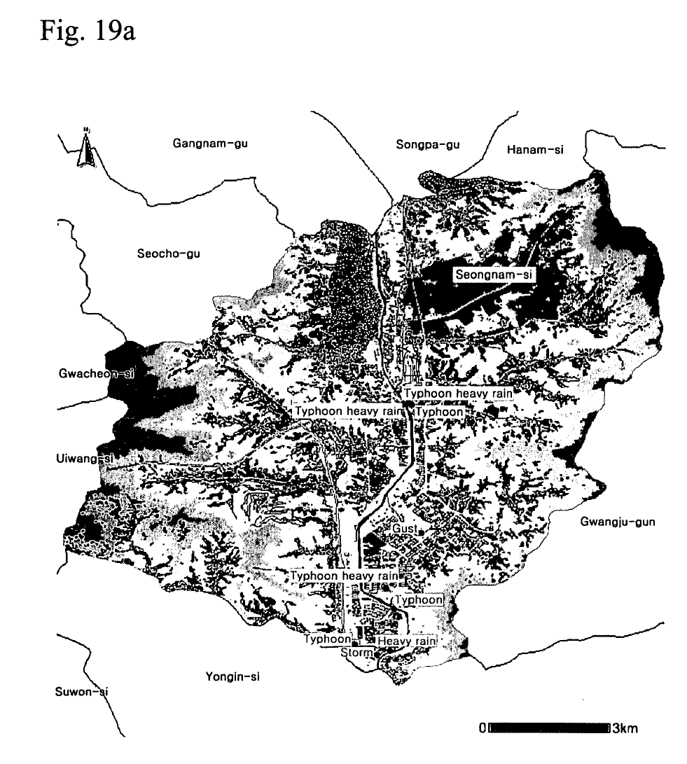

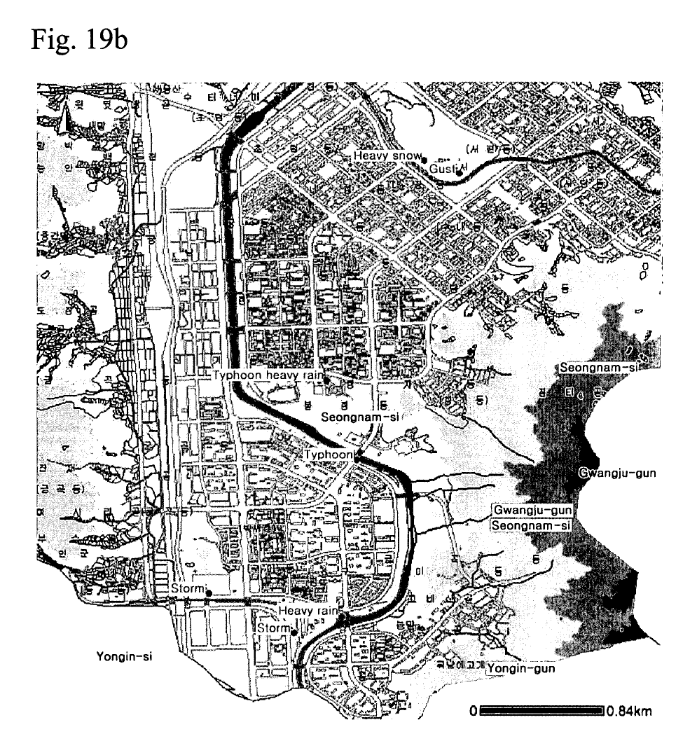

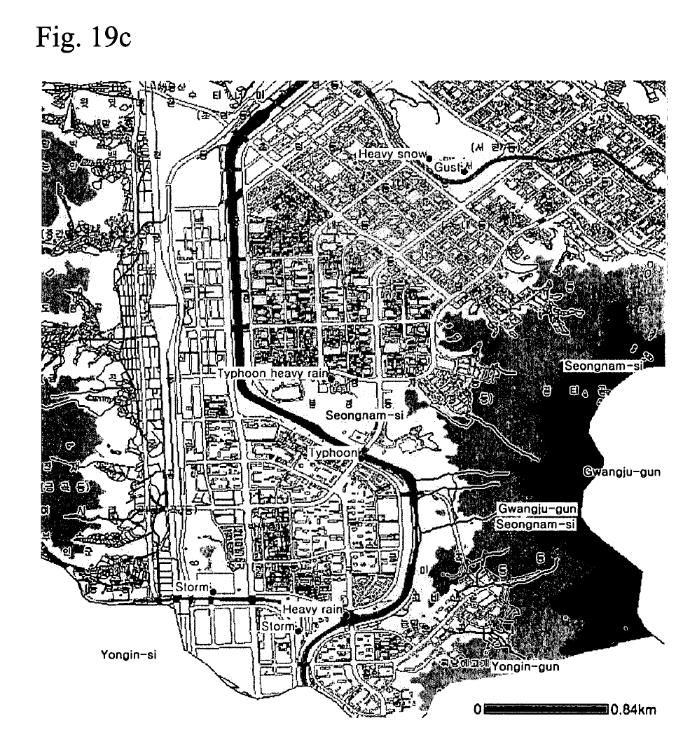

FIGS. 19A, 19B, and 19C are map frame area screens when all the layers are represented in the layer tree area, each of them being a classification screen for showing an example of gradation of layer representation among the issues related to the web-GIS. FIG. 19A is an illustration of a map frame area of a large scale, FIG. 19B is an illustration of a map frame area of a medium scale, and FIG. 19C is an illustration of a map frame area of a small scale.

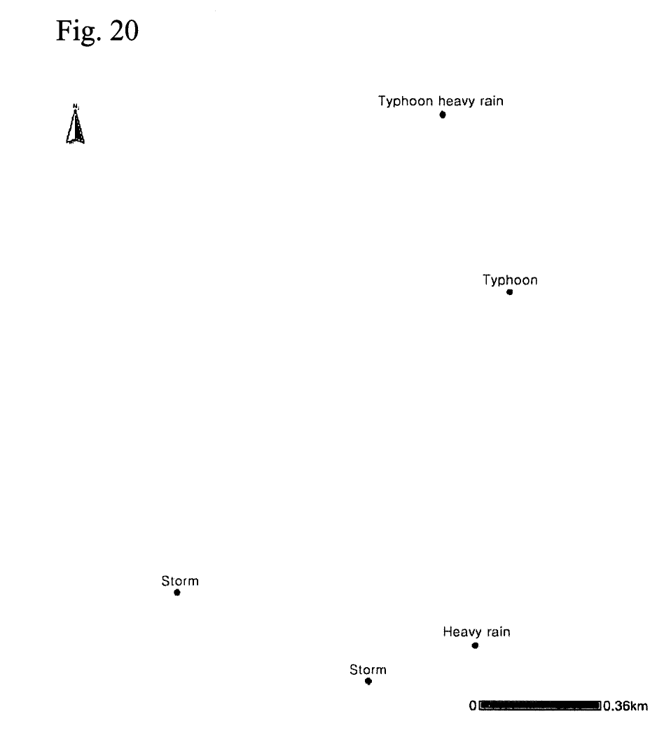

FIG. 20 is a view for showing an example of actual disaster representation added by an on-site investigation group in the map frame area, which is a result of operation for outputting all the disaster information layers, with all the basic information layers not being outputted in the layer tree area. As for expression of a disaster in the map frame area, a damage type is identified by the color of a point according to two basic categories of disasters, and a disaster cause is directly indicated in characters on the left upper end.

One scenario is assumed for illustrative expression of the entire system connection, and is shown in the following Table 3.

TABLE 3
Virtual Scenario

| | | | Date of | Cause | Classification |
|---|---|---|---|---|---|
| | | | investi- | of natural | of disaster |
| Location | Longitude | Latitude | gation | disaster | damage |
| Geumgok | 127.108 | 37.363 | 12:30, | Heavy | Washout |
| Bridge, | | | January 1, | rain | (code: 05) |
| Seongnam | | | 2007 | (code: 03) | |
| City | | | | | |

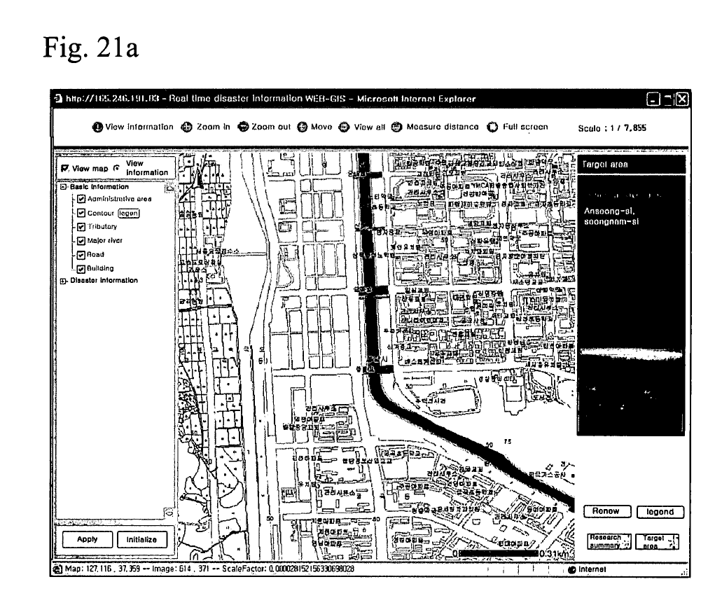

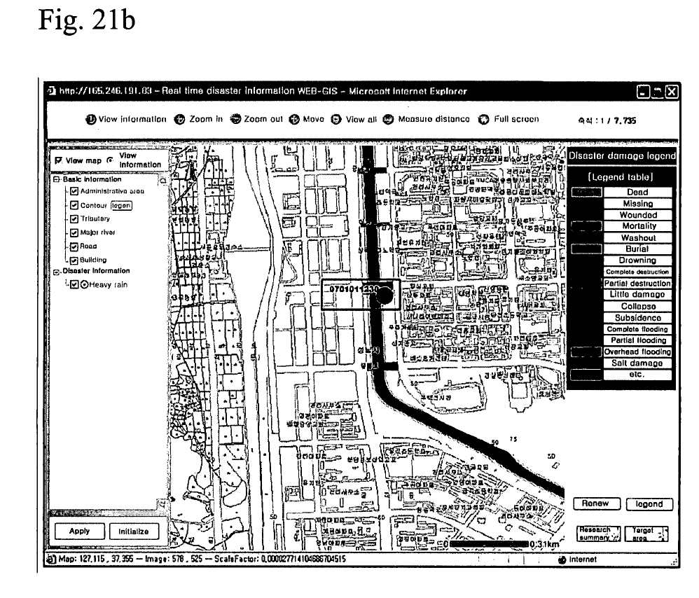

FIG. 21A is a web-GIS screen before the application of the scenario, and FIG. 21B is a screen after the application of the scenario. As can be seen in the red rectangle of FIG. 21B, a red point is created on the actual position corresponding to Geumgok Bridge in Korea, and a heavy rain layer is generated in the left layer tree area.

The present invention can be embodied in various forms. For example, a system having an additional procedure of automatic estimation of the amount of damage can be configured by comparing information of an on-site disaster damage investigation group with a reference amount of damage by facility and damage scale publicly announced by the Ministry of Construction and Transportation of Korea.

The present invention can be expanded into a decision-making support system or expert system which links to and expresses information that can help in establishing measures by the use of a deducted result.

The system is not limited to a procedure of disaster damage investigation but the system can be extensively configured with respect to every social and geographical phenomenon as well as disaster prevention.

As seen from above, the present invention can solve the imbalance of resources to be restored caused by omission in damage investigation or overestimation of quantities, efficiently manage the budget for restoration, and can prevent a disaster recurrence, minimize a second loss and promote the stability of residents at an early stage by a quick restoration promotion of social and life infrastructures.

Especially, it is expected that the present invention can greatly contribute to solving the seeds for disputes among a nation, local authorities of affected areas, and residents thereof caused by the declaration of a disaster area, which is becoming a significant issue in recent years, and estimate the scale of damage and quickly and objectively calculate a disaster restoration cost of an appropriate extent for the purpose of reasonable distribution of and effective investment of national finances.

Accordingly, an extensive application of the result of the present invention can develop and improve advanced disaster prevention techniques capable of quickly, objectively and effectively coping with serious damage from storm and flood that occurs all over the world, such as the typhoons Lusa and Mamie in Korea or the hurricane Katrina in the United States.

In addition to damage from storm and flood, the present invention is applicable to every natural disaster cause and damage type publicly announced by the Ministry of Government Administration and Home Affairs of Korea. Further, for an extensive use, the present invention is applicable to a system capable of supporting to make decisions, such as the establishment of damage restoration measures and the establishment of disaster prevention policies by quick estimation of the amount of damage and construction of an expert system.

While the present invention has been described with respect to the particular embodiments, it will be apparent to those skilled in the art that various changes and modifications may be made without departing from the spirit and scope of the invention as defined in the following claims.

What is claimed is:

1. A real time automatic update system for disaster damage investigation using wireless communication and a web-GIS (Geographic Information System), the system comprising:
a field equipment kit which is comprised of various kinds of equipments for capturing the location of a damaged area, damage cause information, damage images and moving images, and voice information and transmitting them to a server;
a damage investigation information receiving server which receives data that is created in the field equipment kit and transmitted therefrom through wireless communication, analyzes/stores disaster data, and classifies/processes the disaster data;
a web server which receives data classified suitably for a homepage, a disaster register, a web-GIS, etc. and establishes a disaster register DB and a web DB;
a web-GIS server which updates and stores geographical information and geographical property information linked with the web server; and
a client terminal which connects to the web server and the web-GIS server to generate a retrieval signal of disaster information and displays the information on the screen,
wherein the field equipment kit comprises;
a portable damage investigation equipment, which includes a digital camera, a voice recorder and a portable GPS (Global Positioning System) terminal, for capturing images and moving images of a disaster area and voice data and obtaining coordinate information of the corresponding disaster area, and which receives data measured in each of the measuring equipments by using WiFi communication, USB, and CD; and
an ultra-speed wireless internet modem which transmits complete data recombined in the portable damage investigation equipment to the damage investigation information receiving server,
wherein the portable damage investigation equipment is set to perform an overall processing operation, including receiving GPS coordinates of a corresponding damaged area from a GPS server through a Wi-Fi type data receiver and automatically setting the same when position information of a damaged area is entered through a key input section and a GPS coordinate setting is selected, receiving image data, moving image data and voice data of a damaged area through a USB type data receiver and loading and outputting the same, performing an information registration processing by entering information through the key input section and linking weather data and web data, and processing corresponding information in a web document and transmitting the same to the damage investigation information receiving server through a HSDPA (High Speed Downlink Packet Access) type data transceiver.

2. The system of claim 1, wherein the damage investigation information receiving server performs an overall processing operation of analyzing corresponding data in comparison with basic disaster data when damaged area information in a web document form is received from the portable damage investigation equipment, storing and registering the same in the disaster DB, classifying the corresponding information into data for the web server and data for the web-GIS server and converting the same into a protocol of the corresponding server, and transmitting the corresponding data to the web server and the web-GIS server.

3. The system of claim 1, wherein the web server performs the process of receiving damaged area information transmitted from the damage investigation information receiving server, classifying the corresponding data into data for registration in a disaster register DB and homepage data and registering them respectively, and linking the corresponding homepage information with the disaster register DB and registering the same.

4. The system of claim 1, wherein the web-GIS server performs the process of receiving damaged area information transmitted from the damage investigation information receiving server, analyzing the corresponding data and determining whether a new layer is required or not, adding new graphic information and property information of the corresponding area if the new layer is required, configuring geographical graphic information and property information of the corresponding area as web-GIS information if the new layer is not required, and linking the same with the disaster register DB for data update.

5. A real time automatic update method for disaster damage investigation using wireless communication and a web-GIS, the method comprising the steps of:
(a) loading information of a disaster area through a field equipment kit and transmitting and registering the same to and in the a disaster investigation information receiving server;
(b) at the disaster investigation information receiving server, classifying the disaster area information into data for data for a web server and data for a web-GIS server and storing the same in the disaster DB, processing the corresponding disaster area information into a protocol operable for each server, and transmitting the same to each server;
(c) at the web server, analyzing the disaster area information transmitted from the disaster investigation information receiving server, creating the same as data for homepage display and disaster register data for webpages and storing the same in a homepage DB and a disaster register DB, and linking the corresponding homepage and the disaster register DB;
(d) at the web-GIS server, analyzing the disaster area information transmitted from the disaster investigation information receiving server, registering layers for new geographical information or additionally registering geographical graphics of the disaster area, and linking the corresponding information with the web GIS disaster register DB and the web server so as to be outputted in linkage with each other; and
(e) connecting to the web server or the web-GIS server through a client terminal and searching and outputting information of a specific disaster area or disaster type.

6. The method of claim 5, wherein the step (a) comprises the steps of:
(a1) driving the portable damage investigation equipment according to the user's input and selection;
(a2) when position information of a damaged area is inputted into a system driving unit of the portable damage investigation equipment, determining at the system driving unit whether a coordinate setting key is inputted;
(a3) if a coordinate setting key is inputted, at the system driving unit, transmitting a positioning request signal to a remote GPS server and receiving coordinate values from the corresponding GPS server and automatically setting the same;
(a4) determining at the system driving unit whether a key signal for input correction is applied;
(a5) if the input correction key is not applied, determining at the system driving unit whether a damage image information loading signal is applied through additional equipments such as a digital camera, a voice recorder and a key input section, wireless ultra-speed communication equipment and so on, whether a moving image/voice information loading signal is applied, whether an input signal of other information such as memos about the corresponding damaged area information is applied, and whether a loading signal of weather data and other web data of the corresponding area is applied through the wireless internet network;
(a6) if a damage image information or image/voice information loading signal is applied from a digital camera or a voice recorder through a USB port, at the system driving unit, receiving the corresponding information and registering the same in a on-site investigation DB;
(a7) if an input signal of other information such as memos about the corresponding damaged area information is applied through a key input section, linking the same with text information inputted together with image/moving image/voice data of the corresponding damaged area and registering the same in the on-site investigation DB;
(a8) if a loading signal of weather data and other web data of the corresponding area is applied through the wireless internet network, at the system driving unit, receiving the corresponding information and outputting the same on the screen;
(a9) it is determined whether a registration signal for the corresponding information is applied, linking the same with the image/moving image/voice text data of the corresponding damaged area and registering the same in the on-site investigation DB;
(a10) determining at the system driving unit whether an additional information loading signal is applied;
(a11) converting the corresponding information into a web document if there is no additional information to be loaded;
(a12) determining at the system driving whether an information input signal of an additional damaged area is applied; and
(a13) transmitting the corresponding information to the damage investigation information receiving server through a HSDPA type data transceiver if the additional damaged area information input signal is not applied.

7. The method of claim 5, wherein the step (e) comprises the steps of:
(e1) at the web server linked to disaster information, receiving a connection signal from the client terminal;
(e2) determining at the web server whether a selection signal of any one of the corresponding recent damage investigation status information is applied from the client terminal;
(e3) determining at the web server whether a selection signal for image information, moving image information, voice information and disaster prevention register of the corresponding investigation information is applied from the client terminal;
(e4) if the selection signal for any one of the information is applied, at the web server, extracting the information corresponding to the selection signal, among the image information, moving image information, voice information and disaster prevention register of the corresponding investigation information, and outputting the same;
(e5) if the web server receives a disaster register search signal from the client terminal, at the web server, determines which key signal is inputted between a periodical search and a key word search from the client terminal;
(e6) extracting information of the range matching with a corresponding period or keyword and outputting the same;
(e7) determining at the web server whether a GIS information search signal linked to the main page of the web server is applied from the client terminal;
(e8) if the GIS information search signal is applied from the client terminal, driving the web-GIS server at the web server;
(e9) determining at the web-GIS server whether a coordinate input signal, a position selection signal or a disaster type selection signal is applied from the client terminal through the web server;
(e10) receiving the corresponding information or a selection signal at the web-GIS server;
(e11) at the web-server, extracting an information code classified as a coordinate, position information, or disaster type inputted or selected from the client terminal and transmitting the information code to the web server;
(e12) at the web server, extracting and outputting disaster information matching with the corresponding information code by using the corresponding information code;
(e13) if there is at least one information searched and outputted by the web server, determining at the web server whether a selection signal of any one information is applied from the client terminal;
(e14) determining at the web server whether a selection signal for an image information, moving image information, voice information and disaster prevention register of the corresponding investigation information is applied from the client terminal;
(e15) if the selection signal for any one of the information is applied, at the web server, extracting the information corresponding to the selection signal, among the image information, moving image information, voice information and disaster prevention register of the corresponding investigation information, and outputting the same;
(e16) determining at the web server whether a key signal related to geographical information, such as a zoom-in signal or zoom-out signal of a corresponding area, a coordinate movement signal, and a distance measurement signal, is generated from the client terminal, and transmitting the key signal to the web-GIS server if the key signal related to the corresponding geographical information is applied;
(e17) at the web-GIS server, extracting zoom-in (or zoom-out) information of an area range by GIS analysis, modifying the corresponding graphic information, and outputting the graphic information within the corresponding area range;
(e18) if a coordinate movement signal is applied, at the web-GIS server, applying a new coordinate by GIS analysis, modifying graphic information, and outputting the corresponding graphic information;
(e19) if a distance measurement signal is applied, at the web-GIS server, receiving a distance designation signal to calculate the corresponding distance and outputting the calculated value;
(e20) determining at the web-GIS server whether a new input signal of GIS information is applied; and
(e21) if the new input signal is not applied, determining whether a corresponding system termination signal is applied or not.
